(19) United States
(12) Patent Application Publication
(10) Pub. No.: US 2006/0118716 A1
(43) Pub. Date: Jun. 8, 2006

(54) Ion excitation in a linear ion trap with a substantially quadrupole field having an added hexapole or higher order field

(75) Inventors: Anthony L. Michaud, Phoenix, AZ (US); Aaron J. Frank, Dublin, OH (US); Donald J. Douglas, Vancouver (CA); Xianzhen Zhao, Vancouver (CA)

Correspondence Address: MILLER, MATTHIS & HULL, ONE NORTH FRANKLIN STREET, SUITE 2350, CHICAGO, IL, 60606, US

(73) Assignee: The University of British Columbia

(21) Appl. No.: 11/269,165

(22) Filed: Nov. 8, 2005

Related U.S. Application Data
(60) Provisional application No. 60/626,312, filed on Nov. 8, 2004.

(51) Int. Cl. H01J 49/00

(52) U.S. Cl. 250/292

(57) ABSTRACT

A two-dimensional substantially quadrupole field is established and maintained to trap a selected group of ions. The field has a quadrupole harmonic with amplitude A₂, and a higher order harmonic with an amplitude A_{N}, A_{N} being greater than 0.1%. The selected group of ions are trapped in the field. An oscillation frequency at a selected amplitude of excitation for the selected group of ions is determined. An excitation field at the selected amplitude of excitation is added to the two-dimensional substantially quadrupole field to deplete ions within a depletion peak having a low frequency side slightly above the oscillation frequency at the selected amplitude of excitation for the selected group of ions.

### RELATED APPLICATION

This application claims the benefit of U.S. provisional application Ser. No. 60/626,312, entitled ION EXCITATION IN A LINEAR QUADRUPOLE ION TRAP WITH AN ADDED OCTOPOLE FIELD, which was filed by A. L. Michaud, A. J. Frank and D. J. Douglas on Nov. 8, 2004, and the entire contents of which are hereby incorporated by reference.

### FIELD

The present invention relates to ion excitation in a linear quadrupole ion trap having a substantially quadrupole field with an added hexapole or higher order field.

### INTRODUCTION

Linear ion traps are finding increasing application in mass spectrometry because the efficiency of ion ejection is greater than that of three-dimensional (3-D) traps, and a linear ion trap can store more ions. A linear quadrupole ion trap typically consists of four parallel electrodes, each with the same geometry, spaced equally from a central axis to form X and Y pairs. Opposite electrodes are connected together to form two-rod pairs. Radio frequency (RF) voltages are applied between the rod pairs. The resulting time dependent electric fields between the rods confine ions radially between the rods. Stopping potentials applied to electrodes at the ends of the quadrupole confine ions axially.

Methods and apparatus have been developed to add higher spatial harmonics, in particular octopole and hexapole fields, to a linear quadrupole field. These methods and related technologies are described in U.S. Pat. No. 6,897,438; U.S. patent application Ser. No. 10/414,491 by Michael Sudakov, Chuan-fan Ding and Donald J. Douglas filed Apr. 16, 2003; and United States Patent Publication No. 20050067564 by Donald J. Douglas, Chuan-Fan Ding, and Frank Londry filed Sep. 17, 2004.

### SUMMARY

In accordance with an aspect of a first embodiment of the invention, there is provided a method of isolating a first group of ions of a first mass-to-charge ratio from a second group of ions of a second mass-to-charge ratio, the first mass-to-charge ratio being greater than the second mass-to-charge ratio. The method comprises: a) establishing and maintaining a two-dimensional substantially quadrupole field to trap ions of mass-to-charge ratios within a selected range of mass-to-charge ratios encompassing both the first mass-to-charge ratio and the second mass-to-charge ratio, wherein the field has a quadrupole harmonic with amplitude A₂, and an octopole harmonic with an amplitude A₄, A₄ being greater than 0.1% of A₂; b) trapping ions of mass-to-charge ratios within the selected range of mass-to-charge ratios; and, c) adding an excitation field to the two-dimensional substantially quadrupole field to deplete the abundance of the second group of ions of the second mass-to-charge ratio, while retaining the first group of ions of the first mass-to-charge ratio.

In accordance with an aspect of a second embodiment of the invention, there is provided a method of isolating a first group of ions of a first mass-to-charge ratio from a second group of ions of a second mass-to-charge ratio, the first mass-to-charge ratio being greater than the second mass-to-charge ratio. The method comprises a) establishing and maintaining a two-dimensional substantially quadrupole field to trap ions of mass-to-charge ratios within a selected range of mass-to-charge ratios encompassing both the first mass-to-charge ratio and the second mass-to-charge ratio, wherein the field has a quadrupole harmonic with amplitude A₂, and a higher order harmonic with an amplitude A_{N}, A_{N} being greater than 0.1% of A₂; b) trapping ions of mass-to-charge ratios within the selected range of mass-to-charge ratios; c) adding an excitation field to the two-dimensional substantially quadrupole field to deplete the abundance of the second group of ions while retaining the first group of ions.

In accordance with an aspect of a third embodiment of the invention, there is provided a method of isolating a selected group of ions from ions of lower mass-to-charge ratio. The method comprises: a) establishing and maintaining a two-dimensional substantially quadrupole field to trap the selected group of ions, wherein the field has a quadrupole harmonic with amplitude A₂, and a higher order harmonic with an amplitude A_{N}, A_{N} being greater than 0.1% of A₂; b) trapping the selected group of ions in the field; c) determining an oscillation frequency at a selected amplitude of excitation for the selected group of ions; d) adding an excitation field at the selected amplitude of excitation to the two-dimensional substantially quadrupole field to deplete ions within a depletion peak having a low frequency side slightly above the oscillation frequency at the selected amplitude of excitation for the selected group of ions.

These and other features of the applicants' teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in anyway.

FIG. 1, in a schematic view illustrates cross sections of electrodes of a linear quadrupole rod set suitable for providing a substantially quadrupole field with an added octopole field, which can be used to implement an aspect of an embodiment of the present invention;

FIG. 2, in a schematic diagram illustrates a linear ion trap time-of-flight system for providing ion excitation in accordance with an embodiment of the invention;

FIG. 3a, in a graph, illustrates experimental resonance peak shapes for removal of reserpine ions with dipole excitation between the larger rods of the rod set of FIG. 1;

FIG. 3b, in a graph, illustrates experimental resonance peak shapes for removal of reserpine ions with dipole excitation between the smaller rods of the rod set of FIG. 1;

FIG. 4, in a graph, plots calculated amplitudes of oscillation for reserpine ions, m/z=609, trapped in a quadrupole field with a 4% added octopole field against shift in the angular excitation frequency from the unperturbed frequency, in accordance with an aspect of an embodiment of the invention;

FIG. 5, in a graph, plots oscillation amplitude against excitation frequency for excitation between the smaller rods (curve a) and the larger rods (curve b) of the rod set of FIG. 1 (m/z=609);

FIG. 6, in a graph, plots, oscillation amplitude against excitation frequency for the x motion in a substantially quadrupole field with a 6% added hexapole field;

FIG. 7, in a graph, plots oscillation amplitude against excitation frequency for the y motion of an ion in a substantially quadrupole field with a 6% added hexapole field;

FIG. 8a, in a graph, plots the ion intensities in MS/MS of reserpine ions at ca. 1.05 mTorr against excitation amplitude, for a conventional rod set;

FIG. 8b, in a graph, plots the ion intensities in MS/MS of reserpine ions at ca. 1.05 mTorr against excitation time, for a conventional rod set;

FIG. 8c, in a graph, plots the ion intensities in MS/MS of reserpine ions at ca. 1.05 mTorr, against excitation amplitude, for the rod set of FIG. 1 with A₄=0.04 and excitation provided between the larger rods;

FIG. 8d, in a graph, plots the ion intensities in MS/MS of reserpine ions at ca. 1.05 mTorr against excitation time, for the rod set of FIG. 1 with A₄=0.04 and excitation provided between the larger rods;

FIG. 8e, in a graph, plots the ion intensities in MS/MS of reserpine ions at ca. 1.05 mTorr, against excitation amplitude, for the rod set of FIG. 1 with A₄=0.04 and excitation provided between the smaller rods;

FIG. 8f, in a graph, plots the ion intensities in MS/MS of reserpine ions at ca. 1.05 mTorr against excitation time, for the rod set of FIG. 1 with A₄=0.04 and excitation provided between the smaller rods;

FIG. 9a, in a graph, plots the ion intensities in MS/MS of reserpine ions at ca. 0.14 mTorr against excitation amplitude, for a conventional rod set;

FIG. 9b, in a graph, plots the ion intensities in MS/MS of reserpine ions at ca. 0.14 mTorr against excitation time, for a conventional rod set;

FIG. 9c, in a graph, plots the ion intensities in MS/MS of reserpine ions at ca. 0.14 mTorr, against excitation amplitude, for the rod set of FIG. 1 with A₄=0.04 and excitation provided between the larger rods;

FIG. 9d, in a graph, plots the ion intensities in MS/MS of reserpine ions at ca. 0.14 mTorr against excitation time, for the rod set of FIG. 1 with A₄=0.04 and excitation provided between the larger rods;

FIG. 9e, in a graph, plots the ion intensities in MS/MS of reserpine ions at ca. 0.14 mTorr, against excitation amplitude, for the rod set of FIG. 1 with A₄=0.04 and excitation provided between the smaller rods;

FIG. 9f, in a graph, plots the ion intensities in MS/MS of reserpine ions at ca. 0.14 mTorr against excitation time, for the rod set of FIG. 1 with A₄=0.04 and excitation provided between the smaller rods;

FIG. 10a, in a graph, plots the ion intensities in MS/MS of reserpine ions at ca. 0.035 mTorr against excitation amplitude, for a conventional rod set;

FIG. 10b, in a graph, plots the ion intensities in MS/MS of reserpine ions at ca. 0.035 mTorr against excitation time, for a conventional rod set;

FIG. 10c, in a graph, plots the ion intensities in MS/MS of reserpine ions at ca. 0.035 mTorr, against excitation amplitude, for the rod set of FIG. 1 with A₄=0.04 and excitation provided between the larger rods;

FIG. 10d, in a graph, plots the ion intensities in MS/MS of reserpine ions at ca. 0.035 mTorr against excitation time, for the rod set of FIG. 1 with A₄=0.04 and excitation provided between the larger rods;

FIG. 10e, in a graph, plots the ion intensities in MS/MS of reserpine ions at ca. 0.035 mTorr, against excitation amplitude, for the rod set of FIG. 1 with A₄=0.04 and excitation provided between the smaller rods;

FIG. 10f, in a graph, plots the ion intensities in MS/MS of reserpine ions at ca. 0.035 mTorr against excitation time, for the rod set of FIG. 1 with A₄=0.04 and excitation provided between the smaller rods;

FIG. 11a, in a graph, shows an MS/MS spectrum of the m/z 285 fragment of morphine-3-β-D-glucuronide with a conventional rod set, 0.053 mTorr, q=0.23, excitation of 20 mV₀₋ₚ at 62.63 kHz applied for 479 ms;

FIG. 11b, is a graph showing an MS/MS spectrum of the m/z 285 fragment of morphine-3-β-D-glucuronide with the rod set of FIG. 1 with A₄=0.040, 0.048 mTorr, excitation of 80 mV₀₋ₚ at 66.37 kHz applied for 452 ms between the smaller rods;

FIG. 12a, in a graph, illustrates an ion trajectory in an ideal quadrupole field, with dipole excitation, m/z=609, q=0.20, 0.14 mTorr of N₂, trapping rf frequency 768 kHz, excitation frequency 54.739 kHz, r₀=4.17 mm at an excitation amplitude 10 mV₀₋ₚ;

FIG. 12b, in a graph, illustrates an ion trajectory in an ideal quadrupole field, with dipole excitation, m/z=609, q=0.20, 0.14 mTorr of N₂, trapping rf frequency 768 kHz, excitation frequency 54.739 kHz, r₀=4.17 mm at an excitation amplitude 35 mV₀₋ₚ;

FIG. 13a is a graph illustrating an ion trajectory in the x direction in a rod set with A₄=+0.04, q=0.2031, 0.14 mTorr, trapping rf frequency 768 kHz, excitation frequency 56.954 kHz at an excitation amplitude 75 mV₀₋ₚ; and,

FIG. 13b is a graph illustrating an ion trajectory in the x direction in a rod set with A₄=+0.04, q=0.2031, 0.14 mTorr, trapping rf frequency 768 kHz, excitation frequency 56.954 kHz at an excitation amplitude 150 mV₀₋ₚ.

### DESCRIPTION OF VARIOUS EMBODIMENTS

Three dimensional (3-D) ion traps can benefit from geometries that distort the field from that of an ideal quadrupole—see for example Franzen, J.; Gabling, R.-H.; Schubert, M.; Wang, Y. Nonlinear Ion Traps, in Practical Aspects of Ion Trap Mass Spectrometry, March R E, Todd J F J ed. CRC Press Boca Raton 1995. V1, 49-167, (hereinafter “reference [1a]”); Wang, Y.; Franzen, J. The non-linear QUISTOR Part 1. Potential distribution in hyperboloidal QUISTORS. Int. J. Mass Spectrom. Ion Proc. 1992, 112, 167-178, (hereinafter “reference [1b]”); Wang, Y.; Franzen, J.; Wanczek, K. P. The non-linear resonance ion trap. Part 2. A general theoretical analysis. Int. J. Mass Spectrom. Ion Proc. 1993, 124, 125-144, (hereinafter “reference [1c]”); Wang, Y.; Franzen, J. The non-linear ion trap. Part 3. Multipole Components in three types of practical ion traps. Int. J. Mass Spectrom. Ion Proc. 1994, 132, 155-172, (hereinafter “reference [1d]”); Franzen, J. The non-linear ion trap. Part 4. Mass selective instability scan with multipole superposition. Int. J. Mass Spectrom. Ion Proc. 1993, 125, 165-170, (hereinafter “reference [1e]”); Franzen, J. The non-linear ion trap. Part 5. Nature of non-linear resonances and resonant ejection. Int. J. Mass Spectrom. Ion Proc. 1994, 130, 1540, (hereinafter “reference [1f]”); Franzen, J. Simulation study of an ion cage with superimposed multipole fields. Int. J. Mass Spectrom. Ion Proc., 1991, 106, 63-78, (hereinafter “reference [1g]”); and Sudakov, M. Effective potential and the ion axial beat motion near the boundary of the first stable region in a nonlinear ion trap. Int. J. Mass Spectrom. 2001, 206, 27-43, (hereinafter “reference [2]”).

The distortions are described mathematically by the addition of higher multipoles to the electric potential—see references [1c], [1d] and [2]. The most widely discussed distortion is the “stretched” ion trap—see reference [2]—which has the end cap electrodes moved out so that the distance to the end cap, z₀, is increased over that of an ideal field, z₀=\sqrt{2}r₀, where r₀ is the distance from the center to the ring electrode. It has been argued that the addition of higher order multipole fields of the correct sign to 3-D traps improves MS/MS efficiency—see references [1c], [1f] and [2]—and allows faster ejection at the stability boundary, see for example, reference [6] and Cai, Y; Peng, W.-P.; Kuo, S.-J.; Chang, H.-C. Calibration of an audio-frequency ion trap mass spectrometer. Int. J. Mass Spectrom. 2002, 214, 63-73, (hereinafter “reference [3]”), to give higher scan speeds and improved mass resolution.

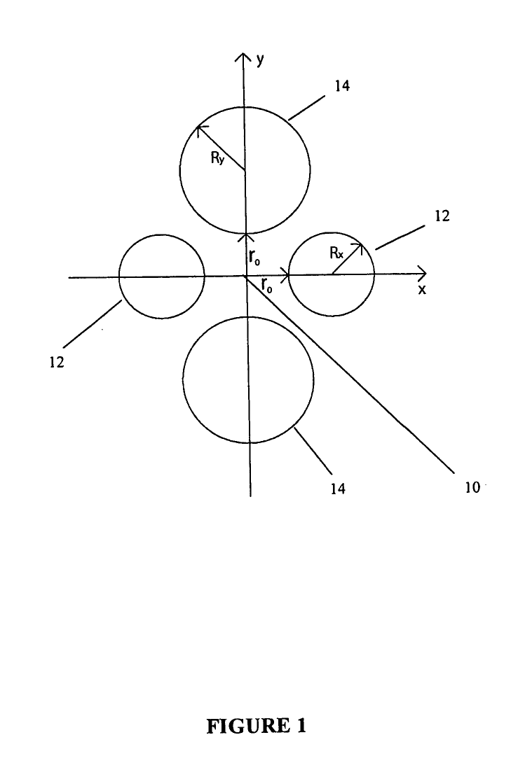

There is increasing interest in using linear quadrupoles as ion traps, both as stand alone mass analyzers with radial ejection (Schwartz, J. C.; Senko, M. W.; Syka, J. E. P. A Two-dimensional Quadrupole Ion Trap Mass Spectrometer. J. Am. Soc. Mass Spectrom. 2002, 13, 659-669, (hereinafter “reference [4]”)) or axial ejection (Hager, J. W. A new linear ion trap mass spectrometer. Rapid Commun. Mass Spectrom. 2002, 16, 512-526, (hereinafter “reference [5]”)), or in combination with other mass analyzers (for a recent review see Douglas, D. J.; Frank, A. J.; Mao, D. Linear Ion Traps in Mass Spectrometry. Mass Spectrometry Reviews 2005, 24, 1-29. (hereinafter “reference [6]”). There is also interest in trapping and exciting ions for MS/MS at the relatively low pressures typical for operation of the last mass analyzing quadrupole in triple quadrupole systems, ca. 3×10⁻⁵ Torr, see for example Collings B. A.; Stott, W. R.; Londry, F. A. Resonant excitation in a low pressure linear ion trap. J. Am. Soc. Mass Spectrom. 2003, 14, 622-634, (hereinafter “reference [7]”). Sudakov, M.; Douglas, D. J. Linear Quadrupoles With Added Octopole fields. Rapid Commun. Mass Spectrom. 2003, 17, 2290-2294, (hereinafter reference [8a]); and, Ding, C.; Konenkov, N. V.; Douglas, D. J. Quadrupole mass filters with octopole fields. Rapid Commun. Mass Spectrom. 2003, 17, 2495-2502, (hereinafter “reference [8b]”), have shown that an octopole field can be added to a linear quadrupole by using rod sets with rods equally spaced from the central axis but with one pair of rods different in diameter than the other pair, as shown in FIG. 1 (see also U.S. Pat. No. 6,897,438) The electric potential within this rod set is given to a good approximation by

$$V ( x , y ) = [ {A}_{0} + {A}_{2} ( \frac{{x}^{2} - {y}^{2}}{{r}_{0}^{2}} ) + {A}_{4} ( \frac{{x}^{4} - 6 {x}^{2} {y}^{2} + {y}^{4}}{{r}_{0}^{4}} ) ] ( U - {V}_{rf} cos Ω t ) \qquad ( 1 )$$

where x is the distance from the center 10 towards a smaller rod 12, y is the distance from the center 10 towards a larger rod 14, r₀ is the distance from the center to any rod, and U and V_{rf} are the amplitudes of dc and radio frequency (rf) voltages applied from pole to ground. In eq 1, A₀, A₂ and A₄ are the dimensionless amplitudes of a constant potential (independent of position), the quadrupole potential and the octopole potential, respectively. The values of A₀ and A₄ are determined by the ratio R_{y}/Rₓ. In general, A_{N} is the amplitude of the 2N-pole potential.

As with 3-D traps, the addition of an octopole field to a linear quadrupole field causes a variety of new effects. In this document we describe modeling of ion motion and experimental investigations of ion excitation in a linear quadrupole trap with a 4% added octopole field (A₄=0.0398). The results are compared to those obtained with a conventional rod set with A₄=0. We derive the effective- or pseudo-potential, see for example, Landau, L. D.; Lifshitz, E. M. 1960 Mechanics 3^{rd} Ed. New York: Pergamon Press, 74-93, (hereinafter “reference [11]”); and, Gerlich, D. 1992, Advances in Chemical Physics LXXXII. Inhomogeneous RF fields: a versatile tool for the study of processes with slow ions, New York: John Wiley and Sons. 1-176, (hereinafter “reference [12]”), arising from the potential of eq 1. Motion of an ion in the effective potential with collisions and excitation is that of a forced, damped, anharmonic oscillator. The frequencies of ion oscillation in the x and y directions shift with increasing amplitude in equal but opposite directions. Excitation profiles for ion ejection or fragmentation become asymmetric and in some cases can show bistable behavior where the amplitude of oscillation suddenly jumps between high and low values with small changes in excitation frequency. Experiments show many of these effects. Ions are injected into a linear trap, stored, isolated, excited for MS/MS, and then ions are mass analyzed in a time-of-flight mass analyzer, see for example, Campbell, J. M.; Collings, B. A.; Douglas, D. J. A linear ion trap time-of-flight system with tandem mass spectrometry capabilities. Rapid Commun. Mass Spectrom. 1998, 12, 1463-1474, (hereinafter “reference [9]”); and, Collings, B. A.; Campbell, J. M.; Mao, D.; Douglas, D. J. A combined linear ion trap time-of-flight system with improved performance and MSⁿ capabilities. Rapid Commun. Mass Spectrom. 2001, 15, 1777-1795, (hereinafter “reference [10]”). Frequency shifts between the x and y motions are observed, and in some cases asymmetric excitation profiles and bistable behavior are observed. Higher MS/MS efficiencies are expected when an octopole field is added. We have measured MS/MS efficiencies (N₂ collision gas) with a conventional quadrupole rod set and a linear ion trap with A₄=0.0398. Efficiencies are compound dependent, but when an octopole field is added, can be substantially higher than with a conventional rod set, particularly at pressures of 5×10⁻⁴ Torr or less.

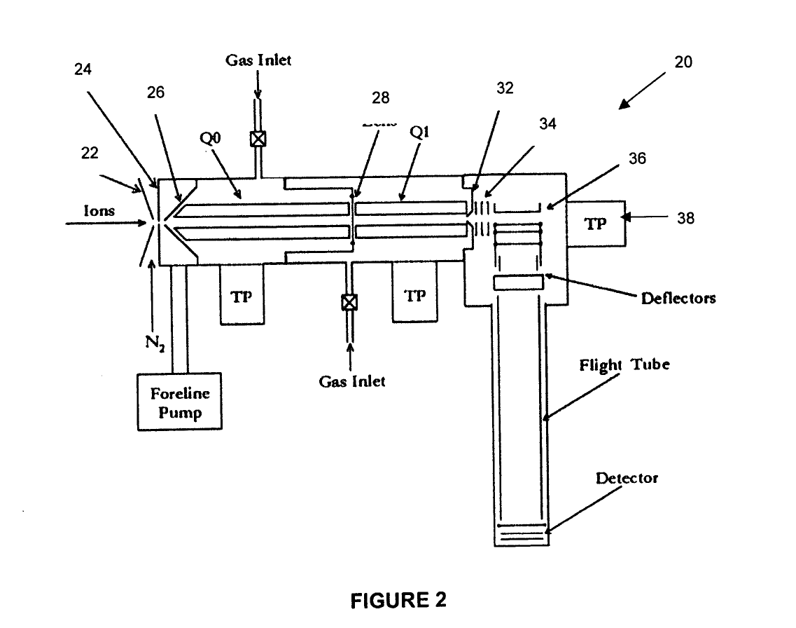

A schematic of the system 20 used, similar to a trap-TOF system described previously, is shown in FIG. 2—see reference [9] and [10]. Ions formed by electrospray pass through a curtain gas and through an aperture in a curtain plate 22 (dry N₂, 99.999% stated purity, Praxair Canada Inc., Delta, BC), and enter the vacuum system through a 0.25 mm diameter orifice in a orifice plate 24 and then a 0.75 mm diameter skimmer orifice in a skimmer plate 26 in a differentially pumped region at a background pressure of 1.0 Torr. Ions then enter a quadrupole ion guide Q0, 30 cm long with a field radius of 4.5 mm, pumped to a pressure of about 3.5 mTorr by a 230 Us turbomolecular pump (TPH 240, Balzers, Nashua, N.H.). Ions then pass through a 2 mm diameter aperture, the entrance lens 28, into a linear quadrupole ion trap Q1, pumped to a base pressure of 3×10⁻⁶ Torr by a 550 L/s turbomolecular pump (TV 551, Varian, Torino, Italy). The pressure in the trap could be increased above the base pressure by adding nitrogen (99.999% stated purity, Praxair Canada Inc.) to the chamber through a needle valve. The trap pressure was measured with an ion gauge for pressures below 1×10⁻⁴ Torr and a 0.1 Torr capacitance manometer for pressures above 1×10⁻⁴ Torr. Both were calibrated against a high precision capacitance manometer (Baratron model 120, manufacturers stated accuracy 0.12% of reading, MKS, Boulder, Colo.). Two traps, Q1, each 20 cm long were used in separate tests: a conventional quadrupole rod set with round rods of length 20 cm and field radius 4.17 mm and ratio of rod radius to field radius r/r₀=1.126, or a quadrupole rod set with a nominal 4% octopole field (A₄=0.0398) and field radius of 4.5 mm (FIG. 1)—see references [8a] and [8b]. The dimensionless amplitudes of the higher order multipoles in these rod sets are shown in Table 1 below. Ions were confined in Q1 by applying trapping potentials to the entrance and exit apertures. Ions then passed through a 2 mm diameter aperture in a cone 32 and three aperture lenses 34, 6.4 mm inside diameter (spacing 2.5 mm), into a source region 36 of a linear time-of-flight (TOF) mass analyzer (R. M. Jordan Co., Grass Valley, Calif., USA). The TOF, with a mass resolution limited to several hundred—see reference [9], is pumped by a 360 L/s turbomolecular pump 38 (Turbovac 361, Leybold, Mississauga, ON) to a base pressure of 3×10⁻⁷ Torr.

TABLE 1
Multipole Amplitudes

| rod set | A₀ | A₂ | A₄ | A₆ | A₈ | A₁₀ |
|---|---|---|---|---|---|---|
| conven- | 0.0000 | 1.00149 | 0.0000 | 0.001267 | 0.0000 | −0.002431 |
| tional | | | | | | |
| 4% | −0.0403 | 1.0056 | 0.03980 | −0.00299 | 0.0008702 | −0.002319 |
| octo- | | | | | | |
| pole | | | | | | |

Isolation waveforms, notched in frequency space, were created with SxWave software (Pan Galactic Scientific, Peterborough, Ontario) using a “comb” of frequencies separated by 250 Hz with random phase. The isolation window notch was 6 kHz, centered at the calculated secular frequency of the ion of interest for an ideal quadrupole rod set. The resulting list of amplitudes was then downloaded via an RS232 interface to an arbitrary waveform generator, (model 33120A, Agilent Technologies, Palo Alto, Calif.). Isolation times were 20 ms and amplitudes were chosen to minimize the background signal with minimal loss of the precursor. Dipole excitation waveforms were generated on a arbitrary waveform generator (SRS DS345, Stanford Research Systems, Sunnyvale, Calif.). Excitation voltages are reported as volts zero to peak, pole to ground (V₀₋ₚ). In a pure quadrupole field the angular frequencies of ion oscillation are given by

$${ω}_{u} = ( 2 n + {β}_{u} ) \frac{Ω}{2} \qquad ( 2 )$$

where n=0, ±1, ±2 . . . , u=x or y, β is a function of the trapping voltage, and Ω is the angular frequency of the trapping rf voltage (Ω=2π768.125 kHz; generated by an API 3 quadrupole power supply (SCIEX, Concord, ON, Canada)). The fundamental frequencies with n=0 were excited.

Sprayer voltages were ca. 4.3 kV. The curtain plate 22 was held at 1.1 kV and the orifice 24 was maintained at ca. 180 V, except when fragmenting morphine-3-β-D-glucuronide in the orfice-skimmer region, when the orifice voltage was increased to ca. 240 V. The skimmer 26 was usually held in the range of 5-12 V and the ion guide rod offset was 2-5 V. The trap entrance aperture plate 28 was at −5 V to +0.5 V and there was no DC offset for the trap. The exit lens 32 was typically at −5 V. To block the passage of ions, the potentials of the entrance or exit lens were set 25 V higher than the lower voltage settings. The lens stack 34 was operated with L1, L2, and L3 at −25 V, −22 V, and −215 V respectively. The TOF source pulsing was controlled by a pulse delay generator (BNC 555, Berkeley Nucleonics, San Rafael, Calif.). This consisted of 20 pulses (width 30 μs) at 380 V and a frequency of 3.333 KHz every time the trap was emptied. Pulsed ions passed through vertical and horizontal deflectors held at −2.5 kV and −2.2 kV, respectively, and into the flight tube, maintained at −2.6 kV. Two microchannel plates in a chevron configuration were used to detect ions.

Timing was controlled using the software package Benchtop Lite (PC Instruments Inc., Lawrence, Kans.) running on a Pentium III desktop PC. For MS/MS, six timing segments were set—emptying, injection, isolation, excitation, cooling, and detection. The periods for trap emptying and injection were 40 ms, for isolation 20 ms, for excitation from 50 ms to about 500 ms, and for detection 10 ms. The cooling period was varied according to the collision gas pressure. Typical cooling times were 10 ms, 20 ms, 100 ms and 500 ms for pressures ranging from 10⁻³ to 10⁻⁶ Torr respectively. These periods were selected such that little increase in the precursor ion signal was observed for longer cooling periods. Spectra were acquired with a multichannel scalar (Turbo-MCS, Ortec International Inc., Atlanta, Ga.) and the associated MCS-32 software package running on a 133 MHz desktop PC. Dwell times were typically 40 ns.

HPLC grade acetonitrile, and HPLC grade methanol were from Aldrich (Sigma-Aldrich, Oakville, ON). Morphine-3-β-D-glucuronide as a stock analytical solution of 2.0 mg/ml in methanol, and reserpine, were from Sigma (Sigma-Aldrich, Oakville, ON). Sample concentrations were typically 50 μM, infused to the ESI source at 1 μL/min. Reserpine was dissolved in pure acetonitrile. Morphine-3-β-D-glucuronide was diluted from the stock solution into a 1:1 mixture of water:methanol with 0.5% v/v acetic acid.

Ion trajectories were simulated using a computer program. Following input of all the data such as rf frequency, Mathieu parameter q, collision gas mass, pressure, and temperature, collision cross section, excitation frequency and amplitude, octopole amplitude A₄, and initial x and y positions and velocities, the equations of motion are integrated to produce values of x and y vs. time. Collisions are included in the trajectories approximately by using a drag coefficient model as described below. An ideal quadrupole field or a quadrupole field with added octopole component could be modeled. Higher spatial harmonics that result from using round rod sets were not included in the trajectory calculations.

Many aspects of ion motion in the linear trap with an added octopole field can be understood by considering the effective potential for the time-dependent potential given by eq 1 with U=0. For an ion of mass m and charge, e, in an inhomogeneous electric field, \vec{E}, oscillating at angular frequency Ω, the effective electric potential—see reference [12]—is given by

$$\begin{matrix}{V}_{eff} = \frac{e {\vert \vec{E} \vert}^{2}}{4 m {Ω}^{2}} \\ where & ( 3 ) \\ {\vert \vec{E} \vert}^{2} = ( {E}_{x}^{2} + {E}_{y}^{2} + {E}_{z}^{2} ) & ( 4 )\end{matrix}$$

In eq 3 and 4 only the spatial dependence of the potential is included. For the potential of eq 1

$$\begin{matrix}{E}_{x} = - \frac{2 {A}_{2} x}{{r}_{0}^{2}} {V}_{rf} - \frac{4 {A}_{4} {x}^{3}}{{r}_{0}^{4}} {V}_{rf} + \frac{12 {A}_{4} {xy}^{2}}{{r}_{0}^{4}} {V}_{rf} \\ and & ( 5 ) \\ {E}_{y} = + \frac{2 {A}_{2} {yV}_{rf}}{{r}_{0}^{2}} + \frac{12 {A}_{4} {x}^{2} {yV}_{rf}}{{r}_{0}^{4}} - \frac{4 {A}_{4} {y}^{3} {V}_{rf}}{{r}_{0}^{4}} \\ with leads to & ( 6 ) \\ {V}_{eff} = \frac{{qA}_{2}^{2} {V}_{rf}}{4} ( \frac{{x}^{2} + {y}^{2}}{{r}_{o}^{2}} ) + \frac{{qA}_{2} {A}_{4} {V}_{rf}}{1} ( \frac{{x}^{4} - {y}^{4}}{{r}_{0}^{4}} ) + … & ( 7 )\end{matrix}$$

where the Mathieu parameter q is given by

$$q = \frac{4 e {V}_{rf}}{{mr}_{0}^{2} {Ω}^{2}} \qquad ( 8 )$$

The first term in eq 7 describes the well-known effective potential for a linear rf-only quadrupole, and the second term describes the modifications caused by the octopole field. Terms in xⁿy^{m} have not been included because we consider here excitation of the x motion when y=0 and excitation of the y motion when x=0. In the direction of the x rods the effective potential increases more rapidly with distance from the centre than that of a pure quadrupole potential, and in the y direction increases less rapidly than that of a quadrupole potential. Thus the effects of positive and negative octopole components can be studied in the same rod set by considering the and y motions respectively.

Motion of a singly charged ion in the x direction in the effective potential of eq 7 is described by

$$m \ddot{x} = {F}_{x} = - e \frac{\partial {V}_{eff}}{\partial x} = - \frac{{eqA}_{2}^{2} {V}_{rf} 2 x}{4 {r}_{0}^{2}} - \frac{4 {eqA}_{2} {A}_{4} {V}_{rf} {x}^{3}}{{r}_{0}^{4}} where \ddot{x} = \frac{{ⅆ}^{2} x}{ⅆ {t}^{2}} . \qquad ( 9 )$$

Equation 9 can be written

$$\begin{matrix}\ddot{x} + {ω}_{0}^{2} x = - \frac{4 {eqA}_{2} {A}_{4} {V}_{rf} {x}^{3}}{{mr}_{0}^{4}} \\ with & ( 10 ) \\ {ω}_{0}^{2} = \frac{{eqA}_{2}^{2} {V}_{rf} 2}{4 {mr}_{0}^{2}} \\ Substituting & ( 11 ) \\ {V}_{rf} = \frac{qm {Ω}^{2} {r}_{0}^{2}}{4 e} \\ gives & ( 12 ) \\ {ω}_{0} = \frac{q {A}_{2} Ω}{\sqrt{8}} & ( 13 )\end{matrix}$$

Equation 13 is the well-known expression for the secular frequency of an ion in a quadrupole field at low q values, see for example, Todd, J. F. J.; Lawson, G.; Bonner, R. F. Quadrupole Ion Traps, in Quadrupole Mass Spectrometry and its Applications, Dawson P. H. ed 1995 AIP Press, Woodbury, New York, (hereinafter “reference [13]”). The octopole field adds the term in x³ to the right of eq 9.

Landau and Lifshitz—see reference [11]—have considered motion of an anharmonic oscillator described by
\ddot{x}+ω₀²x=−αx²−βx³ (14)
Equation 14 is the same as eq 9 when

$$α = 0 and β = \frac{4 {eqA}_{2} {A}_{4} {V}_{rf}}{{mr}_{0}^{4}} .$$

(The term −αx² on the right of eq 14 can be contributed to the effective potential when a hexapole field is added to the potential of eq 1). The anharmonic terms on the right of eq 14 cause shifts in the resonant frequency away from ω₀, given—see reference [11]—by

$$Δ ω = ( \frac{3 β}{8 {ω}_{0}} - \frac{5 {α}^{2}}{12 {ω}_{0}^{3}} ) {b}^{2} \qquad ( 15 )$$

where b is the amplitude of oscillation. Thus the octopole field causes a frequency shift given by

$$Δ ω = \frac{3 {eqA}_{2} {A}_{4} {V}_{rf}}{2 {mr}_{0}^{4} {ω}_{0}} {x}^{2} \qquad ( 16 )$$

Substituting for V_{rf} from eq 12 gives

$$Δω = 3 \frac{{A}_{4}}{{A}_{2}} ( \frac{{b}_{2}}{{r}_{0}^{2}} ) {ω}_{0} \qquad ( 17 )$$

The same result was derived by Sevugarajan and Menon, see for example, Sevugarajan, S.; Menon, A. G. Field Imperfection Induced Axial Secular Frequency Shifts In Nonlinear Ion Traps. Int. J. Mass Spectrom. 1999, 189, 53-61, (hereinafter “reference [14]”), for z motion in the effective potential of a 3-D ion trap with an added octopole field. Although eq 17 was derived from the effective potential approximation, which is normally considered valid for q<0.4, numerical simulation and more detailed calculations show it is a reasonable approximation up to q≈0.85—see, for example, Sudakov, M.; Kumashiro, S. Theory and Simulations of resonance excitation of ion vibrations in non-linear and pure quadrupole ion traps, Part 1, presented at the 51^{st} ASMS Conference on Mass Spectrometry and Allied Topics, Montreal, Jun. 8-12, 2003, (hereinafter “reference [15]”). Thus when A₄>0 (x motion) there is a shift to higher frequency which is proportional to A₄ and to the square of the amplitude of ion oscillation. For A₄<0 (y motion) there is a shift to lower frequency of the same magnitude for the same amplitude of oscillation.

The next highest term in the multipole expansion of the rod set of FIG. 1 is the 12 pole (dodecapole) term, A₆. The potential for a quadrupole with added dodecapole is

$$\begin{matrix}{V}_{eff} = [ {A}_{2} ( \frac{{x}^{2} - {y}^{2}}{{r}_{0}^{2}} ) + {A}_{6} ( \frac{{x}^{6} - 15 {x}^{4} {y}^{2} + 15 {x}^{2} {y}^{4} - {y}^{6}}{{r}_{0}^{6}} ) ] \\ ( U - {V}_{rf} cos Ω t )\end{matrix} \qquad ( 18 )$$

With an added dodecapole with A₆>0, the potential changes more rapidly than the potential of a pure quadrupole field in both the x and y directions. This gives an effective potential that increases in the x and y directions more rapidly than the effective potential of a pure quadrupole field. Thus the frequencies of oscillation shift up with increasing amplitude for both the x and y directions.

Axis Potential

From eq 1, these rod sets have an axis potential A₀ (U−V cosΩt) where A₀≈−A₄ [8a]. The axis potential does not effect ion motion within the linear trap because it is independent of position and therefore produces no electric fields. However it can effect introduction of ions or draining of ions through the fringing fields at the ends of the trap. The axis potential can be removed by applying a greater voltage to the smaller rods and a lower voltage to the larger rods. When the rf was unbalanced in this way to make the axis potential zero, the signal observed in an experiment where ions were trapped and then allowed to drain into the TOF mass analyzer increased by 20%. Thus the axis potential does not have a large effect on the efficiency of ion injection or extraction from the trap. The experiments described here were done with balanced rf applied to the rods.

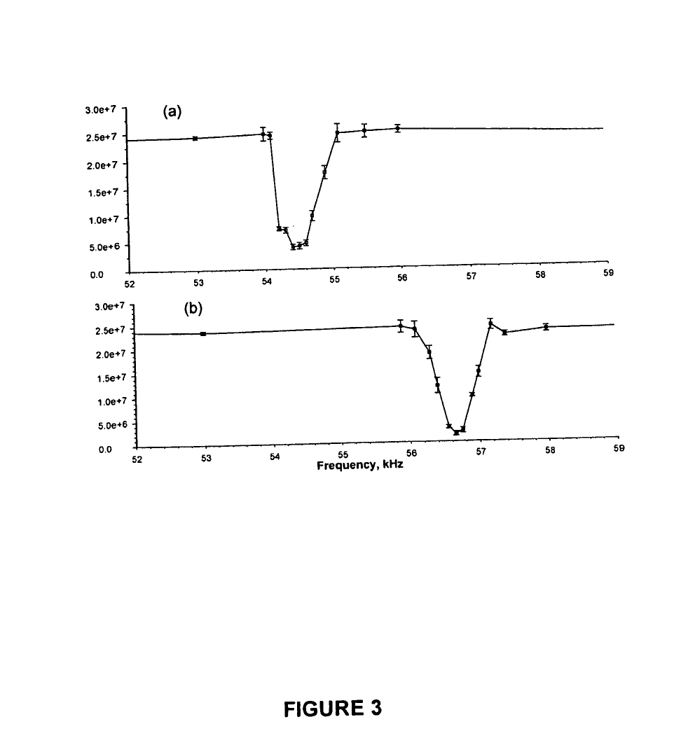

FIG. 3 shows the results of an experiment to measure the frequencies and peak shapes for depletion of protonated reserpine ions with dipole excitation applied between the larger (FIG. 3a) and smaller (FIG. 3b) rods. The background pressure was 1.95 mTorr of N₂ and ions were excited for 30,000 cycles of the excitation waveform at different frequencies (551 ms in FIGS. 3a and 529 ms in FIG. 3b). The excitation amplitudes, 189 mV₀₋ₚ in FIGS. 3a and 272 mV₀₋ₚ in FIG. 3b, were chosen to produce approximately equal depletions in both cases. After excitation, ions were transferred to the source region of the TOF for mass analysis and the intensity of the reserpine ions was measured. It is immediately apparent that the resonances for the two directions have different frequencies. The calculated unperturbed frequency of motion ω₀/2π for q=0.2021 (β0.144088) is 55.338 kHz. The resonance for excitation between the smaller rods which have a positive A₄ in the effective potential model shows a shift up from 55.338 kHz of 1.37 kHz, and for excitation between the larger rods a shift down by 0.89 kHz. For equal amplitudes of oscillation, equal frequency shifts are expected (eq 17). The unequal shifts may simply be due to nonlinearities of the electronics. The trap rf voltage on the rods is set by a mass command voltage (0-10 V dc) to produce 0-5000 V₀₋ₚ, pole to ground, on the rod set. A nonlinearity in the electronics of less than 0.5%, so that the actual voltage applied was 0.43% greater than calculated, would shift the unperturbed frequency to 55.578 kHz and result in equal calculated frequency shifts of ±1.13 kHz for the x and y motions. It is also possible there is a somewhat greater frequency shift for the x motion because a somewhat higher excitation amplitude was used (272 mV₀₋ₚ compared to 189 mV₀₋ₚ). Higher order multipoles can also contribute to the frequency shifts. The next highest amplitude in the multipole expansion is A₆=−0.002990 (Table 1). Because A₆<0, this is expected to cause shifts down in frequencies for both the x and y directions. Thus motion in the direction of the larger rods will receive a shift down from both the octopole and dodecapole terms. Motion in the direction of the small rods will receive a shift up in frequency from the octopole term and a shift down from the dodecapole term. The net result should be a greater shift down in frequency in the direction of the large rods. This is not what is seen. Within the accuracy of this experiment, additional shifts from this multipole cannot be detected.

The depletion of reserpine ions in FIG. 3 is not directly related to the amplitude of oscillation in any simple way, since it corresponds to removal of ions by dissociation following collisional activation—see reference [10]. Nevertheless, from eq 17, frequency shifts of 0.89 kHz and 1.37 kHz correspond to amplitudes of oscillation b=0.37r₀, and b=0.46r₀. (Equal shifts of ±1.13 kHz would correspond to b=0.41r₀.) These amplitudes indicate that the ions are lost by dissociation, not ejection. This is consistent with experiments that show high MS/MS efficiency under similar conditions, presented below.

The peak shown in FIG. 3a is asymmetric, with a sharp side at lower frequencies and a tail to higher frequencies. An asymmetric peak is expected from motion in the effective potential given by eq 7. As described by Landau and Lifshitz—see reference [11]—a plot of the amplitude of oscillation vs. excitation frequency for forced oscillation of the oscillator described by eq 14 is no longer symmetric about the resonant frequency ω₀. The forced anharmonic motion with damping is described by
\ddot{x}+2λ\dot{x}+ω₀²x=(f/m)cos γt−αx²−βx³ (19)
where λ is a damping constant and f is the amplitude of the driving force with angular frequency γ. If β is positive (A₄>0, excitation between the smaller rods) then a plot of amplitude of oscillation vs. frequency shows a sharper side on the high frequency side of the peak. If β is negative (A₄<0, excitation between the larger rods) the sharper side is the low frequency side, as seen in FIG. 3a. Asymmetric peaks have been seen in 3-D traps and attributed to field distortions, but the connection to specific multipoles, to the sign of the multipoles, or to effective potentials has received little discussion. For example, March, R. E.; Weir, M. R.; Tkaczyk, M.; Londry, F. A.; Alfred, R. L.; Franklin, A. M.; Todd, J. F. J. Kinetic Energy Effects in an Ion Ensemble Subjected to Mass-selective Isolation and Resonance Excitation: a Simulation Study, Organic Mass Spec. 1993, 28, 499-509, (hereinafter “reference [16]”), attributed frequency shifts in a 3-D trap to higher order components of the field, but did not discuss these shifts in terms of multipoles. Williams, J. D.; Cox, K. A.; Cooks, R. G.; McLuckey, S. A.; Hart,. K. J.; and, Goeringer, D. E. Resonance Ejection Ion Trap Mass Spectrometry and Nonlinear Field Contributions: the Effect of Scan Direction on Mass Resolution. Anal Chem. 1994, 66, 725-729, (hereinafter “reference [17]”), observed asymmetric peaks with a tail to the low frequency side for excitation of ions of butylbenzene in a stretched 3-D trap, although again the results were not discussed in terms of multipoles of the potential. In an ion trajectory simulation of motion in a stretched trap, Splendore et al., (Splendore M.; Londry, F. A.; March R. E.; Morrison, R. J. S.; Perrier, P.; Andre, J. A. Simulation study of ion kinetic energies during resonant excitation in a stretched ion trap. Int. J. Mass Spectrom. Ion Proc. 1996, 156, 11-29, (hereinafter “reference [18]”)), found a frequency shift approximately proportional to the square of the amplitude of ion motion, with a shift to higher frequency for z motion and to lower frequencies for r motion, as expected from eq 17. If the frequency shift observed by Spiendore et al.—see reference [18]—is attributed to the presence of an octopole with no other higher multipoles, an octopole component of ca. 1% can be calculated from eq 17. Alheit et al., (Alheit, R.; Chu, X. Z.; Hoefer, M.; Holzki, M.; Werth, G. Nonlinear collective oscillations of an ion cloud in a Paul trap. Phys. Rev. A 1997, 56, 4023-4031, (hereinafter “reference [19a]”)) found an asymmetric peak with a tail to the high frequency side, for quadrupole excitation of the collective motion of ions in a 3-D trap with ideal geometry. The asymmetry was attributed to an added hexapole field which causes the frequency of oscillation to decrease as the amplitude increases. The same group reported asymmetric peaks for excitation of higher order resonances (n>0 in eq 2). For the higher order resonances the effective potential approximation no longer applies and it was found peaks could have tails on either the low or high frequency sides, (Chu, X. Z.; Holzki, M.; Alheit, R.; Werth, G. Observation of high-order motional resonances of an ion cloud in a Paul trap. Int. J. Mass Spectrom. Ion Proc. 1998,173,107-112 (hereinafter “reference [19b]”)); and, Nappi et al. (Nappi, M.; Frankevich V.; Soni, M.; Cooks, R. G. Characteristics of a broad band Fourier transform ion trap mass spectrometer. Int. J. Mass Spectrom. 1998, 177, 91-104, (hereinafter “reference [20]”)) observed shifts to lower frequency for z motion in a stretched trap; the shifts were attributed to addition of 1.4% octopole and 3% hexapole to the 3-D field, although the frequency shifts caused by these added fields were not calculated.

The low frequency side of the peak in FIG. 3a shows an abrupt change from no depletion at 54.10 kHz, to a 70% loss of signal at 54.20 kHz. This sharp change could be a result of bistable behavior, expected for a nonlinear oscillator, and caused by the anharmonic terms on the right of eq 19—see reference [11] and, Bologoliubov, N. N.; Mitropolsky, Y. A. Asymptotic Methods in the Theory of Non-Linear Oscillations, 245, Hindustan Publishing Corporation, Delhi, India, 1961. (hereinafter “reference [22]”); and also see, Makarov, A. A. Resonance Ejection from the Paul Trap: A Theoretical treatment Incorporating a Weak Octapole Field. Anal. Chem. 1996, 68, 4527-4263, (hereinafter “reference [23]”). In other experiments we have observed a sharp transition with a change of frequency as little as 1 Hz. Bistable behavior has been observed in 3-D traps by Alheit et al, —see reference [19a] and Chu et al.—see reference [19b] and attributed to anharmonicities in the potential. In their work, a sharp boundary on the low frequency side of the resonance was attributed to the presence of an added hexapole potential, which causes the frequency of oscillation to decrease with increasing amplitude.

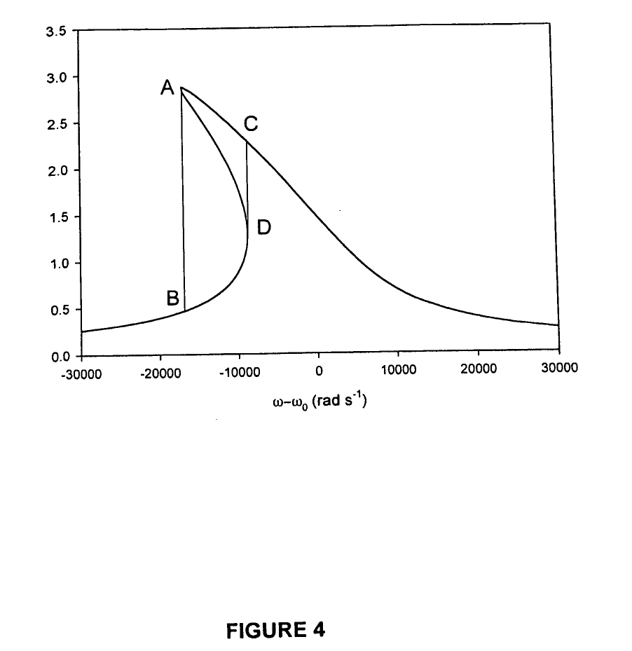

As the driving force in eq 18 increases, a plot of the amplitude of oscillation vs. driving frequency becomes increasingly asymmetric, and at a critical force, f_{c}, bi-stable behavior is formed—see reference [11]. With a negative octopole potential, the form of the curve of amplitude of oscillation vs. excitation frequency takes on the appearance of FIG. 4. The amplitude of oscillation, b, is related to the driving frequency through

$$ɛ = κ {b}^{2} \pm \sqrt{[ {( \frac{f}{2 m {ω}_{0} b} )}^{2} - {λ}^{2} ]} \qquad ( 21 )$$

where ε=γ−ω₀, see reference [11].
The critical force is given by

$${f}_{c}^{2} = \frac{32 {m}^{2} {ω}_{0}^{2} {λ}^{3}}{3 \sqrt{3} κ} \qquad ( 22 )$$

where κ is related to the frequency shift by ω=ω₀+κb²
From eq 17

$$κ = 3 \frac{{A}_{4}}{{A}_{2}} ( \frac{1}{{r}_{0}^{2}} ) {ω}_{0} \qquad ( 23 )$$

For example in our rod set with A₄/A₂=0.04, r₀=4.5×10⁻³ m and ω₀≈2π5.5×10⁴ s⁻¹, κ=2.05×10⁹ s⁻¹ m⁻².

The damping constant, λ, can be related to the collision cross section and gas number density with a drag coefficient model, see for example, Chen, Y.-L.; Collings, B. A.; Douglas, D. J. Collision Cross Sections of Myoglobin and Cytochrome c ions with Ne, Ar, and Kr. J. Am. Soc. Mass Spectrom. 1997, 8, 681-687, (hereinafter “reference [21]”), which gives the force on an ion as

$${F}_{d} = - \frac{{C}_{d} σ {nm}_{2} {v}^{2}}{2} \qquad ( 23 b )$$

where C_{d} is a drag coefficient, σ the collision cross section, n the gas number density, m₂ the collision gas mass, and v the ion speed. If the drag force on a particle is F_{d}=−αν Landau and Lifshitz—see reference [11] define a damping constant by

$$\frac{{α}^{′}}{m} = 2 λ \qquad ( 24 )$$

For low ion speeds,

$${C}_{d} = \frac{3.01 \sqrt{2 kT / {m}_{2}}}{v} \qquad ( 25 )$$

where T is the gas temperature and m₂ is the collision gas mass—see reference [21]. Thus

$$\begin{matrix}{F}_{d} = \frac{- 3.01 \sqrt{2 kT / {m}_{2}} σ {nm}_{2} v}{2} \\ so that & ( 26 ) \\ {α}^{′} = \frac{3.01 \sqrt{2 kT / {m}_{2}} σ {nm}_{2}}{2} \\ and & ( 27 ) \\ λ = \frac{{α}^{′}}{2 m} = \frac{3.01 \sqrt{2 kT / {m}_{2}} σ {nm}_{2}}{4 m} & ( 28 )\end{matrix}$$

For ions of reserpine trapped at 2.0×10⁻³ Torr of N₂ at 295 K, λ=2.67×10³ s⁻¹. (σ=280 Å,²) Javahery, G.; Thomson, B. A. A Segmented Radiofrequency-Only Quadrupole Collision Cell for Measurements of Ion Collision Cross Section on a triple Quadrupole Mass Spectrometer. J. Am. Soc. Mass Spectrom. 1997, 8, 697-702, (hereinafter “reference [24]”) Thus the critical force for reserpine ions under these conditions is f_{c}=2.65×10⁻¹⁸ N. The force is related to the electric field, E, by f=eE, so the electric field that produces this critical force on a reserpine ion is calculated to be 16.6 V m⁻¹.

The electric field with dipole excitation can be calculated for the rod geometry of FIG. 1 by the method of equivalent charges, see for example Douglas, D. J.; Glebova, T. A.; Konenkov, N. V.; Sudakov, M. Y. Spatial Harmonics of the Field in a Quadrupole Mass Filter with Circular Electrodes. Tech. Phys. 1999, 44,1215-1219, (hereinafter “reference [25]”). The dipole potential within the rods is given by

$${ϕ}_{1} = {A}_{1} ( \frac{u}{{r}_{0}} ) V cos ω t \qquad ( 29 )$$

where u is x or y and the electric field is

$$E = - {A}_{1} ( \frac{V}{{r}_{0}} ) cos ω t \qquad ( 29 )$$

The amplitudes of the dipole field, A₁, produced in the rod sets used in these experiments were calculated with the results shown in Table 2 below. Thus to produce an electric field with amplitude 16.6 V m⁻¹ requires an excitation voltage between the large rods of

$$V = \frac{16.6}{0.826} 4.5 ⨯ {10}^{- 3} = 0.090$$

V zero to peak, pole to ground. The data of FIG. 4 were calculated from eq 19 using these values of κ, λ, and eq 30 to convert the force from the 189 mV₀₋ₚ voltage to a force on an ion of 5.6×10⁻¹⁸ N.

TABLE 2
Amplitudes of the dipole field for different rod sets and rod pairs

| ratio of rod radii | excitation | A₁ |
|---|---|---|
| 1.516 | small rods | 0.775 |
| 1.516 | large rods | 0.826 |
| 1.000 | either rod pair | 0.798 |

FIG. 4 shows that, starting at a low frequency, as the frequency is increased the amplitude of oscillation increases. However beginning at the point B there are three possible solutions for the amplitude. If the frequency of excitation is increased, ions can follow the curve to D, then suddenly jump in amplitude to C. If the frequency of excitation is decreased, starting at the right of FIG. 4, ions can follow the upper curve past C to A where the amplitude suddenly decreases. The use of this type of behavior to improve scan speed and ion ejection from a 3-D trap has been described by Makarov—see reference [23].

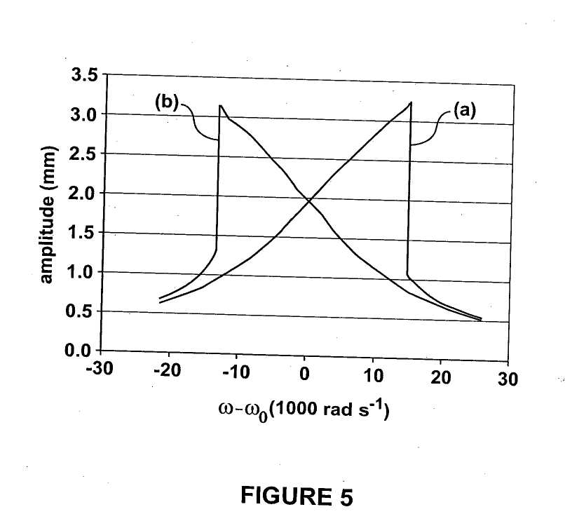

When a positive octopole component is present, as with excitation between the smaller rods, the curve also has bistable behavior but the curve is reflected about the ω−ω₀=0 axis. Thus we would expect to see a sharp side on the high frequency side of the peak. The data of FIG. 4 are based on an approximate solution to eq 18, which is itself an approximation based on the effective potential. To more accurately determine the amplitudes of oscillation, trajectory calculations were used to determine the amplitude of oscillation for different excitation frequencies, with the results shown in FIG. 5. The curve “a” is for excitation of ions between the smaller rods and the curve “b” for excitation between the larger rods. For this calculation the conditions were m/z=609, A₄=0.040, q=0.2026, excitation amplitude 0.25 V₀₋ₚ, pressure 2.0 mTorr of N₂, σ=280 Å², trapping rf frequency 768 kHz, r₀=4.5 mm, initial x and y positions 0.1r₀, initial x and y velocities 0. The sudden change in amplitude with frequency can be seen clearly in each case. In the trajectory calculations the difference in frequency between the point of highest amplitude and the next point of much lower amplitude is 1 Hz. Similar excitation profiles which showed a sharp transition on the high frequency side of the peak were reported by Splendore et al. for simulations of ion motion in the z direction of a stretched 3-D trap, see for example Splendore M.; Londry, F. A.; March R. E.; Morrison, R. J. S.; Perrier, P.; Andre, J. A. Simulation study of ion kinetic energies during resonant excitation in a stretched ion trap. Int. J. Mass Spectrom. Ion Proc. 1996, 156, 11-29, (hereinafter “reference [18]”). The results were not interpreted in terms of the addition of multipoles or anharmonic oscillations.

Despite these expectations from modeling the motion in the effective potential and from direct trajectory calculations, a sharp side on the high frequency side of the peak is not seen in FIG. 3b. This might be attributed to the presence of the dodecapole component of field. As described above, in the direction of the small rods the dodecapole field leads to a smaller frequency shift than in the direction of the large rods, and this could change the conditions required for bistable behaviour.

It has been argued that MS/MS efficiencies increase when higher multipoles are added to a 3-D trap—see reference [1c][1f] and [2]. The same improvements might be expected for a linear trap—see reference [7] and [8a]. MS/MS efficiencies were measured for reserpine ions trapped in a conventional rod set and in the rod set with 4% octopole field. The effects of pressure, excitation amplitude and excitation time were investigated. In all experiments, ions were trapped at q=0.20 with excitation for 100 ms, and the excitation amplitude was varied. Then the excitation was kept fixed at approximately the amplitude that gave 50% depletion of the precursor ion, and the excitation time was varied.

Hexapole

Frequency shifts can also be induced by the addition of a hexapole to a quadrupole potential, and addition of a hexapole should also increase MS/MS efficiency. Methods and apparatus for providing a two-dimensional substantially quadrupole field with a selected hexapole component are described in United States Patent Publication No 20050067564 published Mar. 31, 2005, the contents of which are hereby incorporated by reference. The potential of a linear quadrupole with an added hexapole is given by

$$V ( x , y ) = [ {A}_{2} ( \frac{{x}^{2} - {y}^{2}}{{r}_{0}^{2}} ) + {A}_{3} ( \frac{{x}^{3} - 3 {xy}^{2}}{{r}_{0}^{2}} ) ] φ ( t ) \qquad ( 31 )$$

where A₂ and A₃ are the dimensionless amplitudes of the quadrupole and hexapole fields, A₂≈1, and r₀/\sqrt{A₂} is the distance from the centre of the quadrupole to a y electrode when x=0, and ±φ(t) is the voltage applied the electrodes.

The frequency shifts that occur when a hexapole field is added to a linear quadrupole field can be calculated within the effective potential approximation. Recall that for an ion of mass m and charge, e, in an inhomogeneous electric field, \vec{E}, oscillating at angular frequency Ω, the effective electric potential—see reference 12—is given by

$$\begin{matrix}{V}_{eff} = \frac{e {\vert \vec{E} \vert}^{2}}{4 m {Ω}^{2}} \\ where & ( 3 ) \\ \vert \vec{E} \vert = ( {E}_{x}^{2} + {E}_{y}^{2} + {E}_{z}^{2} ) & ( 4 )\end{matrix}$$

For the potential of eq 31 when φ(t)=V_{rf} cos Ωt eq 3 and 4 lead to

$${V}_{eff} ( x , y ) = \frac{{qA}_{2}^{2} {x}^{2}}{4 {r}_{0}^{2}} {V}_{rf} + \frac{3 {qA}_{2} {A}_{3} {x}^{3}}{4 {r}_{0}^{3}} {V}_{rf} + \frac{9 {qA}_{3}^{2} {x}^{4}}{16 {r}_{0}^{4}} {V}_{rf} + \frac{{qA}_{2}^{2} {y}^{2}}{4 {r}_{0}^{2}} {V}_{rf} + \frac{9 {qA}_{3}^{2} {y}^{4}}{{16}_{0}^{4}} {V}_{rf} + \qquad ( 32 )$$

Higher order terms x^{m}yⁿ have not been included because we are interested in the x motion when y=0, and the y motion when x=0. To first order in A₃, the hexapole does not cause a shift in the frequency of oscillation because, while the force increases more rapidly than that of a harmonic oscillator in the positive x direction, it increases less rapidly in the negative x direction. However in second order it does cause a frequency shift. Motion in the x direction in the effective potential of eq 32 is determined by

$$\begin{matrix}m \ddot{x} = {F}_{x} = - e \frac{\partial {V}_{eff} ( x , y )}{\partial x} \\ which leads to & ( 33 ) \\ \ddot{x} + {ω}_{0}^{2} x = - \frac{9 {eqA}_{2} {A}_{3}}{4 {mr}_{0}^{3}} {V}_{rf} {x}^{2} - \frac{36 {eqA}_{3}^{2}}{16 {mr}_{0}^{4}} {V}_{rf} {x}^{3} \\ with & ( 34 ) \\ {ω}_{0}^{2} = \frac{{eqA}_{2}^{2} {V}_{rf} 2 x}{4 {mr}_{0}^{2}} \\ or & ( 35 ) \\ {ω}_{0} = \frac{{qA}_{2}}{\sqrt{8}} Ω & ( 36 )\end{matrix}$$

The left side of eq 34 describes the secular motion of an ion trapped in a quadrupole field at low q values and the right side describes the modifications caused by the hexapole fields. Equation 34 is of the form

$$\begin{matrix}\ddot{x} + {ω}_{0}^{2} x = - α {x}^{2} - β {x}^{3} \\ with & ( 14 ) \\ α = \frac{9}{2} ( \frac{{A}_{3}}{{A}_{2}} ) \frac{{ω}_{0}^{2}}{{r}_{0}} and β = \frac{9 {A}_{3}^{2}}{2 {A}_{2}^{2}} \frac{{ω}_{0}^{2}}{{r}_{0}^{2}} & ( 37 )\end{matrix}$$

The solution of eq 14 has been described by Landau and Lifshitz—reference 11. The terms on the right of eq 14 cause a shift in the frequency of ion oscillation given by

$$Δ ω = ( \frac{3 β}{8 {ω}_{0}} - \frac{5 {α}^{2}}{12 {ω}_{0}^{3}} ) {b}^{2} \qquad ( 15 )$$

where b is the amplitude of oscillation. Thus the term in α in eq 34 and 37 causes a shift down in frequency of

$$Δ {ω}_{α} = - \frac{5}{12} \frac{81 {A}_{3}^{2}}{4 {A}_{2}^{2}} \frac{{b}^{2}}{{r}_{0}^{2}} {ω}_{0} \qquad ( 38 )$$

This shift was calculated by Sevugarajan and Menon (reference 14) for the z motion in a 3D trap with an added hexapole field. The term in β in eq 34 and 37 causes a shift up of

$$Δ {ω}_{β} = + \frac{3 β}{8 {ω}_{0}} {b}^{2} = + \frac{27 {A}_{3}^{2}}{16 {A}_{2}^{2}} \frac{{b}^{2}}{{r}_{0}^{2}} {ω}_{0} \qquad ( 39 )$$

For example, if A₃=0.02 and b=r₀, Δω_{α}=−3.38×10⁻³ ω₀ and Δω_{β}=+6.75×10⁻⁴ ω₀ The combined frequency shift for the x motion (Δωₓ=Δω_{α}+Δω_{β}) is −2.71×10⁻³ ω₀.

The motion in the y direction is determined by

$$\ddot{y} + {ω}_{0}^{2} = - \frac{36 ⅇ {qA}_{3}^{2}}{16 {mr}_{0}^{4}} {V}_{rf} {y}^{3} \qquad ( 40 )$$

This gives a shift up in frequency

$$Δ {ω}_{y} = \frac{27 {A}_{3}^{2}}{16 {A}_{2}^{2}} \frac{{b}^{2}}{{r}_{0}^{2}} {ω}_{0} \qquad ( 41 )$$

When A₂=1.0, A₃=0.020 and b=r₀ this shift is +6.75×10⁻⁴ω₀, opposite in sign and four times less than the total shift in the x frequency.

A hexapole produces smaller shifts than an octopole of the same amplitude. A positive octopole of amplitude A₄ in the x direction produces a shift in frequency of ion excitation—see for example Anthony Michaud, Aaron Frank, Chuanfan Ding, XianZhen Zhao and Donald Douglas, Ion Excitation in a Linear Quadrupole Ion Trap with an Added Octopole Field, Journal of the American Society for Mass Spectrometry 2005, 19, 803 (hereinafter “reference [27]”).

$$Δ {ω}_{x} = 3 \frac{{A}_{4}}{{A}_{2}} \frac{{b}^{2}}{{r}_{0}^{2}} {ω}_{0} \qquad ( 17 )$$

If A₄=0.02 and b=r₀ this shift is 0.06ω₀ or about 22 times greater than that of a hexapole of the same amplitude.

An asymmetric peak is expected from motion in the effective potential given by eq14. As described by Landau and Lifshitz (reference 11), a plot of the amplitude of oscillation vs. excitation frequency for forced oscillation of the oscillator described by eq 34 is no longer symmetric about the resonant frequency ω₀. The forced anharmonic motion with damping is described by
\ddot{x}+2λ\dot{x}+ω₀²x=(f/m)cos γt−αx²−βx³ (19)
where λ is a damping constant and f is the amplitude of the driving force with angular frequency γ.

The amplitude of oscillation, b, is related to the driving frequency through

$$ɛ = κ {b}^{2} \pm \sqrt{[ {( \frac{f}{2 m {ω}_{0} b} )}^{2} - {λ}^{2} ]} \qquad ( 21 )$$

where ε=γ−ω₀—see reference 11.
The critical force is given by

$${f}_{c}^{2} = \frac{32 {m}^{2} {ω}_{0}^{2} {λ}^{3}}{3 \sqrt{3 } κ} \qquad ( 22 )$$

where κ is related to the frequency shift by ω=ω₀+κb²
Comparison to eq 39 and 40 shows for the x motion

$$κ = ( - \frac{5}{12} \frac{81}{4} \frac{{A}_{3}^{2} {ω}_{0}}{{A}_{2}^{2} {r}_{0}^{2}} + \frac{27}{16} \frac{{A}_{3}^{3} {ω}_{0}}{{A}_{2}^{2} {r}_{0}^{2}} ) \qquad ( 42 )$$

and for the y motion

$$κ = ( + \frac{27}{16} \frac{{A}_{3}^{3} {ω}_{0}}{{A}_{2}^{2} {r}_{0}^{2}} ) \qquad ( 43 )$$

The methods to calculate the force on an ion and the damping coefficient are described above and in reference [27].

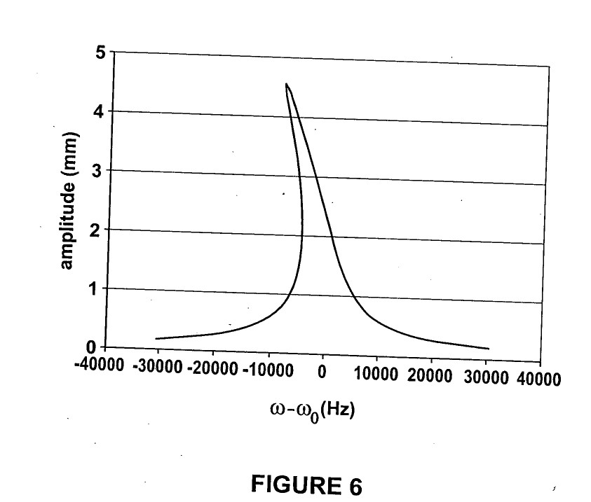

FIG. 6 shows a graph of oscillation amplitude vs. excitation frequency calculated from eq 21 for the x motion in a quadrupole with 6% added hexapole field (A₃=0.06) and no other higher order terms. The left side of the peak shows bistable behaviour. The operating conditions are as follows: rₒ=4.5 mm A₃=0.060, m/z 609, collision gas N₂, cross section 280 Å² T=295 K, 1×10⁻³ torr, 0.15 V_{0-P} pole to ground, trapping rf frequency 768 kHz, q=0.2026. There is more than one possible amplitude for a given excitation. As described in references 11 and 27 this is likely to produce sudden jumps in amplitude with small changes in the excitation frequency.

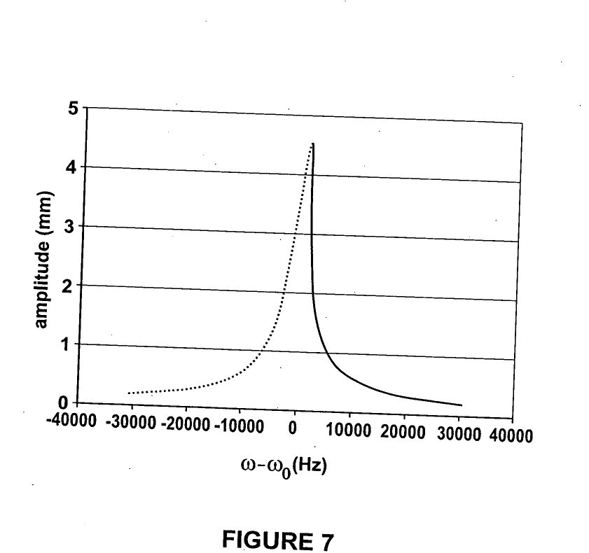

FIG. 7 shows a graph of oscillation amplitude vs. excitation frequency for the y motion and the same operating conditions. The operating conditions are as follows: rₒ=4.5 mm A₃=0.060, m/z 609, collision gas N₂, cross section 280 Å², T=295 K, 1×10⁻³ torr, 0.15V _{0-P} pole to ground, 768 kHz, q=0.2026. The peak is asymmetric, but because the frequency shift in the y direction is about four times less than for the x direction, the asymmetry is reduced and amplitude jumps may not be seen. Thus with an added hexapole field, sudden jumps and a sharp side are more likely to be produced on the low frequency side.

Other Higher Order Odd Multipoles

From the form of the potential for higher order odd multipoles, we can expect that each of the higher multipoles will also make a depletion peak sharper on one side than another. Consider the form of the potential with an added hexapole.

$$V ( x , y ) = [ {A}_{2} ( \frac{{x}^{2} - {y}^{2}}{{r}_{0}^{2}} ) + {A}_{3} ( \frac{{x}^{3} - 3 {xy}^{2}}{{r}_{0}^{2}} ) ] φ ( t ) \qquad ( 31 )$$

When y=0 we can consider the x motion.

$$V ( x , y = 0 ) = [ {A}_{2} ( \frac{{x}^{2}}{{r}_{0}^{2}} ) + {A}_{3} ( \frac{{x}^{3}}{{r}_{0}^{3}} ) ] \qquad ( 44 )$$

If A₃>0, the potential increases more rapidly than a pure quadrupole in the positive x direction and less rapidly in the −x direction. In first order these effects cancel, but, in second order there is a frequency shift, which can lead to sharp sides on the low frequency side of a peak.

Now consider the y motion when x=0.

$$V ( x = 0 , y ) = [ {A}_{2} ( \frac{- {y}^{2}}{{r}_{0}^{2}} ) + {A}_{3} \cdot 0 ] φ ( t ) \qquad ( 45 )$$

Putting x=0 in eq 31 leaves only a term in y², and in this approximation there is no change to the y motion. Thus a bigger change occurs in the x motion, giving a bigger frequency shift for the x motion and a sharper side on the low frequency side of the peak.

Now consider a quadrupole with added decapole (N=5)

$$V ( x , y ) = [ {A}_{2} ( \frac{{x}^{2} - {y}^{2}}{{r}_{0}^{2}} ) + {A}_{5} ( \frac{{x}^{5} - 10 {x}^{3} {y}^{2} + 5 {xy}^{4}}{{r}_{0}^{5}} ) ] φ ( t ) \qquad ( 46 )$$

Consider the x motion when y=0

$$V ( x , y = 0 ) = [ {A}_{2} ( \frac{{x}^{2}}{{r}_{0}^{2}} ) + {A}_{5} ( \frac{{x}^{5}}{{r}_{0}^{5}} ) ] φ ( t ) \qquad ( 47 )$$

As with a hexapole, the x motion is perturbed by the additional term in the potential. This gives frequency shifts and a sharp side on the low frequency side of the peak.

Now consider the y motion when x=0

$$V ( x = 0 , y ) = [ {A}_{2} ( \frac{- {y}^{2}}{{r}_{0}^{2}} ) + {A}_{5} \cdot 0 ] φ ( t ) \qquad ( 48 )$$

In this approximation the y motion is not perturbed. Thus there is a greater effect on the x motion, an asymmetric peak is formed and it is sharper on the low frequency side.

The same argument can be made from the form of the potential for higher odd multipoles

$$\begin{matrix}N = 7 {A}_{7} ( \frac{{x}^{7} - 21 {x}^{5} {y}^{2} + 35 {x}^{3} {y}^{4} - 7 {xy}^{6}}{{r}_{0}^{7}} ) & ( 49 ) \\ N = 9 {A}_{9} ( \frac{{x}^{9} - 36 {x}^{7} {y}^{2} + 126 {x}^{5} {y}^{4} - 84 {x}^{3} {y}^{6} + 9 {xy}^{8}}{{r}_{0}^{9}} ) & ( 50 )\end{matrix}$$

And so on.

The sharp side of the depletion peak—representing a sharp drop in the abundance of ions of a particular m/z range—can be used to separate isotopes that differ very slightly in terms of their mass-to-charge ratio. Say, for example, that we wish to separate a first isotope from a second isotope. The first isotope has a mass-to-charge ratio that is only very slightly greater than the second mass-to-charge ratio. Alternatively, the sharp low frequency side of the depletion peak can be used to separate molecular ions of organic compounds that contain different isotopes. For example, molecular ions of an organic compound may include an isotope or isotopes of carbon or oxygen that produces a slightly lower or higher mass-to-charge ratio than other molecular ions of the same compound. These isotopomers contain different isotopes of the same element, and can be separated using the method described below.

According to aspects of an embodiment of an invention, a two-dimensional substantially quadrupole field can be established and maintained to trap both the first and second isotopomers. In addition to this quadrupole component, the substantially quadrupole field also includes a higher order component field, whether a hexapole harmonic, an octopole harmonic or other higher order odd harmonic. In some embodiments, the amplitude of the higher order harmonic is greater than 0.1% of the amplitude of the quadrupole component of the substantially quadrupole field. In other embodiments, the higher order harmonics, such as an octopole for example, would exceed 1% of the amplitude of the quadrupole harmonic, or even 3% of the amplitude of the higher order harmonic.

An excitation field can be added to the substantially quadrupole field to resonantly eject the second isotopomer, while retaining the first isotopomer. That is, as the low frequency side of the peak is so steep or sharp, most of the ions of the second isotopomer can be fragmented or ejected, while concurrently retaining ions of the first isotopomer. To determine the appropriate excitation frequency, at a particular excitation magnitude, one would first determine an oscillation frequency for the first group of ions at the selected amplitude of excitation. Then, the excitation field at the selected amplitude of excitation would be selected to provide a low frequency side of the depletion peak that is slightly above the oscillation frequency for the first group of ions. As a result, the first group of ions would, for the most part, not be resonantly excited by the excitement field. At the same time, the low frequency side of the depletion peak produced by the excitation field would be selected to be just below or at the oscillation frequency for the second group of ions at that oscillation magnitude. Thus, the second group of ions would be fragmented or ejected by the excitation field.

As described in more detail in U.S. Pat. No. 6,897,438, the contents of which are hereby incorporated by reference, an octopole harmonic can be added to a substantially quadrupole field by supplying a first voltage to a first pair of rods of the rod set of FIG. 1, and a second voltage to a second pair of rod set of FIG. 1. Both the first voltage and the second voltage are at least partially A/C. The transverse dimension of the first rod pair can be selected to be sufficiently greater than the transverse dimension of the second rod pair to add the desired octopole harmonic to the field. As shown in FIG. 1, the rods can be substantially cylindrical.

Using the rod set of FIG. 1 to provide a substantially quadrupole field with an added octopole component, the excitation field can then be added by providing dipole excitation between one of the two pairs of rods. For example, dipole excitation may be provided between the first rod pair, which is of larger diameter than the second rod pair.

In some embodiments, the second voltage supply to the second pair of rods can be increased by a voltage misbalance amount, while the first voltage applied to the first pair of rods can be decreased by the voltage misbalance amount. The voltage misbalance amount is selected to minimize an axis potential of the field, which can facilitate transmission of ions to a downstream detector or other device.

In other embodiments of the invention, ions of the first isotope can be ejected to a detector for detection after ions of the second isotope have been resonantly ejected.

MS/MS Efficiencies

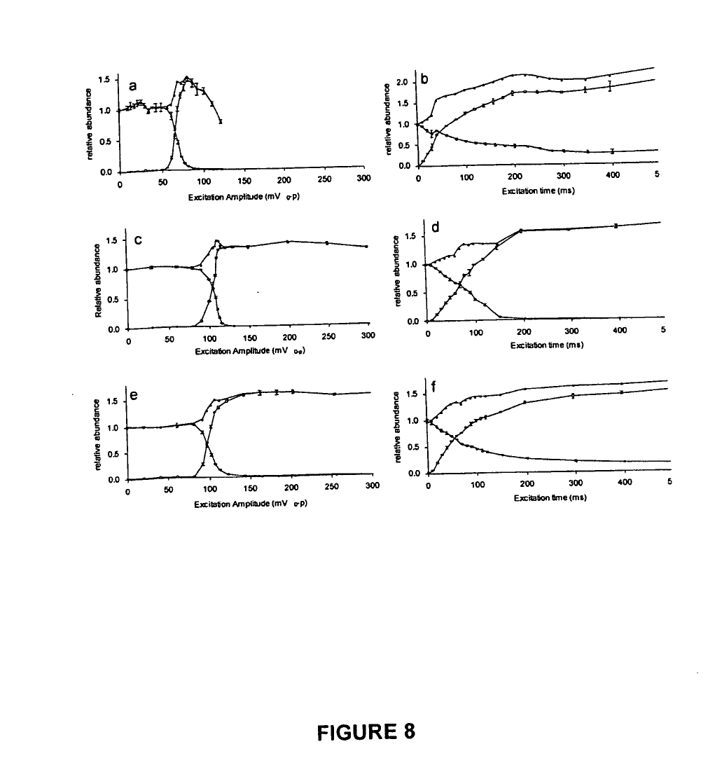

FIGS. 8a-8f show the results of experiments at a pressure of ca. 1.05 mTorr. Each plot in FIGS. 8a-8f shows the abundance of parent ions, the sum of all fragment ions and the sum of all ions in the mass spectrum. The data are not corrected for mass discrimination in transferring the ions into or through the TOF analyzer. FIG. 8a shows the ion abundances obtained with a conventional rod set (excitation frequency 54.2 kHz) operated at 1.08 mTorr. As the excitation voltage is increased the parent ion decreases in intensity, the fragment ions increase and the sum of all ions increases somewhat. The parent and sum of fragment ion intensities are equal at an excitation amplitude of 69 mV₀₋ₚ. At higher excitation amplitudes the fragment ion abundances increase and the precursor ions are efficiently converted to fragment ions. FIG. 8b shows the effects of increasing the excitation time with a conventional rod set operated at 1.08 mTorr (excitation amplitude 69 mV₀₋ₚ). At excitation times up to 500 ms the fragment ion abundances continue to increase, although the precursor ion is never completely removed.

FIGS. 8c and 8d show similar plots for the rod set with 4.0% octopole with dipole excitation applied between the larger rods of the rod set of FIG. 1, operated at 1.05 mTorr. FIG. 8c shows that as the excitation amplitude is increased from zero (excitation frequency 54.0 kHz), the parent ions decrease in abundance, the fragment ion intensities increase, and at an amplitude of 106 mV₀₋ₚ the product and precursor ion abundances are equal. At higher excitation amplitudes all precursor ions are converted to fragment ions. FIG. 8d shows the effect of varying the excitation time between the larger rods with an amplitude of 106 mV₀₋ₚ. At greater excitation times again the product ion abundances increase. FIGS. 8e and 8f show the effects off changing the excitation amplitude and excitation time with dipole excitation between the smaller rods of the rod set of FIG. 1, operated at 1.08 mTorr (excitation frequency 56.9 kHz). The results are similar to those with excitation between the larger rods. At an excitation amplitude of 96 mV₀₋ₚ the abundance of precursor and fragment ions are about equal; at higher amplitudes precursors are efficiently converted to product ions. With an amplitude of 96 mV₀₋ₚ, as the excitation time is increased a greater fraction of precursors is converted to fragments.

The data of FIGS. 8a-8f show that at a pressure of 1.05 mTorr of N₂, reserpine ions can be efficiently converted to product ions in every case. The rod sets with added octopole field offer little improvement in MS/MS efficiency over a conventional rod set. A comparison of FIGS. 8a, 8c and 8e shows that with the added octopole field, ions can be excited at greater amplitudes than in a conventional rod set, without loss of ions. With a conventional rod set, the sum of all ions begins to decrease at an amplitude of about 100 mV₀₋ₚ whereas with the 4% octopole rod set, the ions can be excited at 300 mV₀₋ₚ without losses. Because of the smaller field radius, for a given excitation voltage, the conventional rod set produces an electric field about 8% greater than the rod set with 4% octopole (Table 2 and eq 30). The differences in excitation voltages that can be applied to the rod set with 4% octopole field are much greater than this difference.

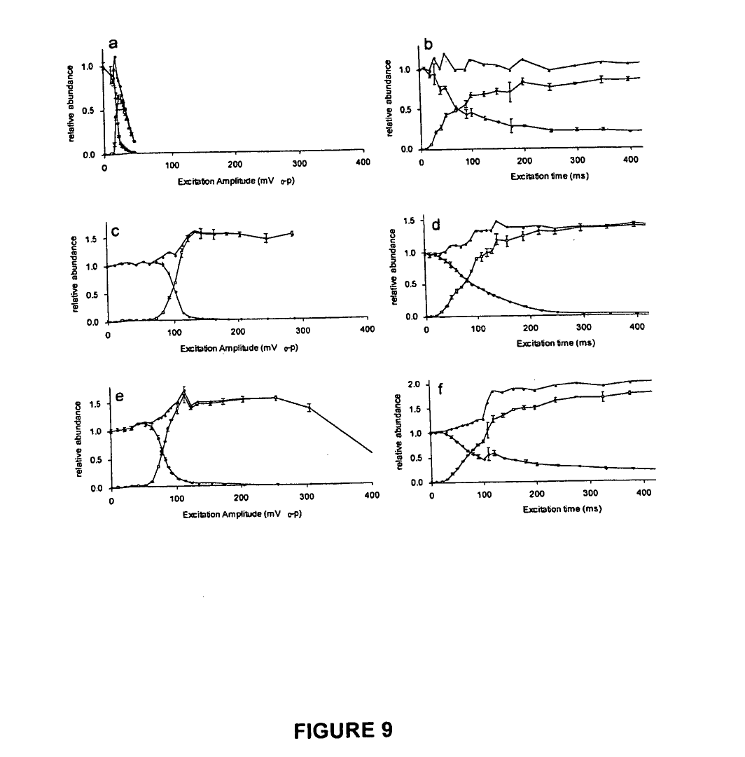

FIGS. 9a to 9f show the results of similar experiments at a pressure of ca. 0.14 mTorr of N₂. FIG. 9a shows the effect of varying excitation amplitude with a conventional rod set (excitation frequency 54.2 kHz). As the amplitude is increased, the precursor ion intensity decreases, the fragment intensities increase and at about 17 mV₀₋ₚ the fragment and precursor ion intensities are equal. At higher amplitudes the fragment ion abundances increase, reaching a maximum at about 33 mV₀₋ₚ. Above ca. 20 mV₀₋ₚ the intensities of all ions decrease. About 60% of the precursor ions can be converted to product ions. FIG. 9b shows the effect of increasing the excitation time in a conventional rod set at an amplitude of 18 mV₀₋ₚ. At greater excitation times the fragment ion abundances increase, but in contrast to FIG. 8b remain less than the initial precursor ion abundance. In comparison to the results shown in FIGS. 8a and 8b, ions are less efficiently converted to fragment ions. FIGS. 9c and 9d show data obtained with excitation between the larger rods (excitation frequency 54.05 kHz). Beginning at an amplitude of ca. 80 mV₀₋ₚ the precursor ion abundance decreases and the fragment ion abundances increase. They are equal at 100 mV₀₋ₚ. At higher amplitudes, precursor ions are efficiently converted to products. Ions can be excited with amplitudes of at least 250 mV₀₋ₚ without substantial losses. FIG. 9d shows the effect of increasing the excitation time with an amplitude of 102 mV₀₋ₚ. Above 100 ms, fragment ion abundances continue to increase and all precursor ions can be converted to fragment ions. FIGS. 9e and 9f show similar experiments with excitation between the smaller rods of the rod set of FIG. 1 (excitation frequency 57.1 kHz). At an excitation amplitude of 81 mV₀₋ₚ the precursor and product ion intensities are equal (FIG. 9e) and above this amplitude, the intensities of fragment ions increase and all precursors can be converted to fragments. FIG. 9f shows that with an excitation amplitude of 81 mV₀₋ₚ, precursor ions can be converted to fragment ions with high efficiencies at excitation times greater than about 250 ms. Overall the data in FIGS. 9a-9f show that ions can be excited with substantially greater amplitudes in the rod set with added octopole field without loss of ions (i.e. the sum of all ions remains approximately constant). Further, the data of FIG. 9 show that the rod set with 4% octopole field has somewhat higher MS/MS efficiency under these operating conditions.

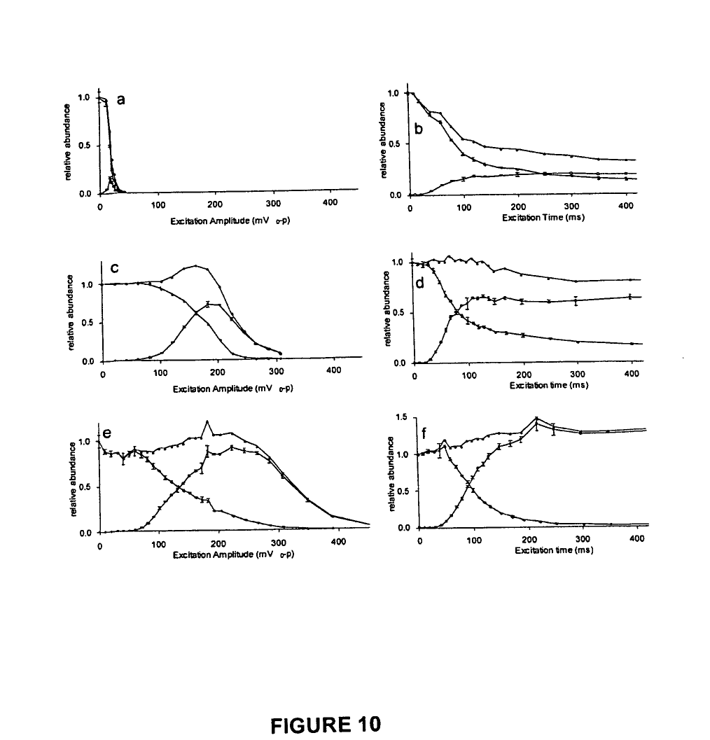

FIGS. 10a-10f show results of experiments at ca. 0.035 mTorr of N₂. FIG. 10a shows the effect of increasing the excitation amplitude with a conventional rod set operated at 0.038 mTorr (excitation frequency 54.2 kHz). As the amplitude is increased from zero, the precursor ion intensity decreases, and product ions are formed with low abundance, reaching a maximum in intensity at about 14 mV₀₋ₚ. At higher amplitudes, all ion intensities decrease and, in comparison to experiments at higher pressures (FIGS. 8a, 9a) the efficiency of converting precursor ions to product ions is poor. FIG. 10b shows that with a conventional rod set operated at 0.038 mTorr, an excitation frequency of 54.2 kHz and an excitation amplitude of 16 mV₀₋ₚ, the abundance of fragment ions increases slightly at excitation times above 100 ms, but remains low. FIGS. 10c and 10d show the same experiment with excitation applied between the larger rods of the 4% octopole field rod set of FIG. 1 operated at 0.030 mTorr (excitation frequency 53.3 kHz). FIG. 10c shows that as the excitation amplitude is increased from zero, the precursor ion intensity decreases and the fragment ion abundances increase, with equal intensities at about 160 mV₀₋ₚ. At higher amplitudes, the fragments increase in abundance, with a maximum at ca. 180 mV₀₋ₚ. At higher amplitudes, the precursor, fragment, and sum of all ions decrease. Nevertheless about 75% of the precursor ions can be converted to fragment ions. FIG. 10d shows the effect of increasing excitation time between the large rods with an amplitude of 183 mV₀₋ₚ. At times greater than about 100 ms the abundance of fragments increases to ca. 70% of the initial precursor intensity. FIGS. 10e and 10f show the results of similar experiments with excitation between the smaller rods of the rod set of FIG. 1 operated at 0.035 mTorr (excitation frequency 57.1 kHz). FIG. 10e shows that as the amplitude increases the precursor ion abundance decreases and the fragment ion abundances increase, with equal intensities at 140 mV₀₋ₚ. At higher amplitudes the fragment ion abundances continue to increase until at around 220 mV₀₋ₚ, the intensities of all ions begin to decrease. FIG. 10f shows the effect of increasing the excitation time with an excitation amplitude of 142 mV₀₋ₚ. Above 100 ms the abundance of fragment ions continues to increase and nearly all precursor ions can be converted to fragment ions.

Comparison of FIGS. 8, 9 and 10 shows that as the pressure decreases below 1 mTorr, the rod set with 4% octopole field shows greater MS/MS efficiencies than a conventional rod set. This is most apparent in FIG. 10 where there are dramatic differences in the excitation profiles. At this pressure, with a conventional rod set, only about 15% (FIG. 10a) to 20% (FIG. 10b) of the precursor ions are converted to fragment ions. With the rod set with 4% octopole field, and with excitation between the larger rods about 70% of the initial precursor intensity appears as fragments. FIGS. 10e and 10f show that with excitation between the smaller rods, nearly all the precursor ions can be converted to fragment ions. Under these conditions, the MS/MS efficiency with the rod set with a 4% added octopole field is about five times greater than a conventional rod set.

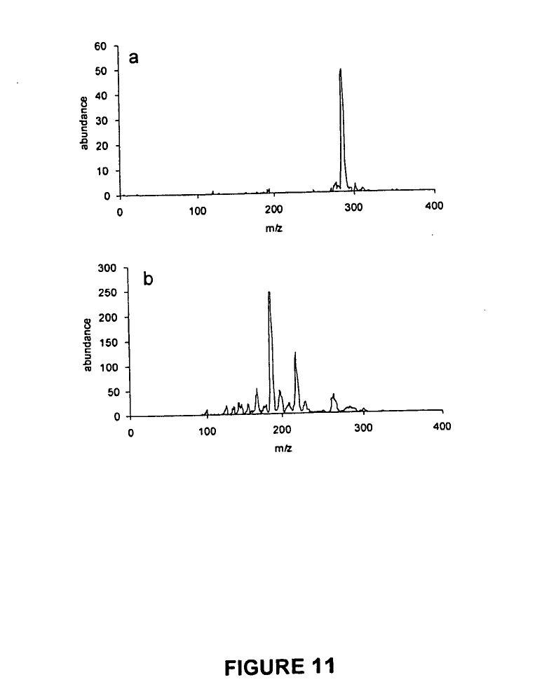

The MS/MS efficiency is expected to be compound dependent. Thus the experiments with reserpine ions were repeated with protonated ions of morphine-3-β-D-glucuronide (a metabolite of morphine). Results similar to those with reserpine ions were obtained (data not shown). When ions of morphine-3-β-D-glucuronide dissociate, they produce a fragment at m/z=286. This fragment ion was found to be more difficult to dissociate than the precursor molecular ion or ions of reserpine. For MS/MS experiments, the m/z 286 fragment was produced by increasing the voltage difference between the orifice and skimmer from 170 V to 220 V, to give the highest abundance of the m/z 286 ion. The m/z 286 fragment ions were then isolated in the linear trap, trapped at q=0.23 and excited for MS/MS at a variety of excitation times. Excitation amplitudes were chosen to give 95%-100% depletion of the m/z 286 ion. Table 3a below shows the MS/MS efficiencies obtained at a pressure of ca. 1 mTorr with a conventional rod set and a rod set with 4% octopole field. Excitation times of 50, 100 and about 480 ms were tested. The latter corresponds to 30,000 cycles of the excitation voltage, the longest time possible with the waveform generator used. At 1 mTorr, the rod sets with 4% octopole field showed MS/MS efficiencies greater by about a factor of two. The rod sets were then tested at a pressure of ca. 0.05 mTorr, with the results shown in Table 3b below. With the conventional rod set, almost no fragment ions could be formed at any excitation time. However with the 4% octopole rods, some fragments could be formed with 100 ms excitation time and with excitation for 480 ms the MS/MS efficiency increases to about 100%. The difference in fragment ion spectra are dramatic. FIG. 11a show the MS/MS spectrum obtained with a conventional rod set. Although there is 93% depletion of the precursor ion, almost no fragment ions are formed. FIG. 11b shows the MS/MS spectrum with excitation between the smaller rods of the 4% octopole rod set. There is 97% depletion of the precursor ion, and abundant fragment ions are formed. The MS/MS efficiency is calculated to be 106%.

The data in Table 3a illustrate another effect. At a pressure of 1 mTorr, and with the rod set with 4% octopole field, 100% MS/MS efficiency was possible with a 50 ms excitation time. To get a similar MS/MS efficiency (77%) with the conventional rod set, an excitation time of 482 ms was required, nearly ten times longer. Thus, under some operating conditions, it seems likely that with the rod set with added octopole field, ions can be dissociated with higher excitation amplitudes and shorter excitation times to improve the duty cycle of an MS/MS experiment.

TABLE 3A
MS/MS efficiencies (%) at ca. 1 mTorr

| | | larger | smaller |
|---|---|---|---|
| | conventional | rods | rods |
| excitation | rod set | (1.09 | (1.04 |
| time | (1.14 mTorr) | mTorr) | mTorr) |
| 50 ms | 41 | 98 | 93 |
| | (63 mV₀₋ₚ) | (115 mV₀₋ₚ) | (100 mV₀₋ₚ) |
| 100 ms | 45 | 99 | 99 |
| | (60 mV₀₋ₚ) | (105 mV₀₋ₚ) | (90 mV₀₋ₚ) |
| 30,000 | 77 | 157 | 144 |
| cycles | (53 mV₀₋ₚ, | (90 mV₀₋ₚ, | (77 mV₀₋ₚ, |
| | 482 ms) | 484 ms) | 457 ms) |

TABLE 3b
MS/MS efficiencies (%) at ca. 0.05 mTorr

| | | larger | smaller |
|---|---|---|---|
| | conventional | rods | rods |
| excitation | rod set | (0.046 | (0.048 |
| time | (0.053 mTorr) | mTorr) | mTorr) |
| 50 ms | 0.0 | 0.1 | 0 |
| | (18 mV₀₋ₚ) | (135 mV₀₋ₚ) | (128 mV₀₋ₚ) |
| 100 ms | 0.1 | 3 | 17 |
| | (19 mV₀₋ₚ) | (120 mV₀₋ₚ) | (115 mV₀₋ₚ) |
| 30,000 | 0.1 | 96 | 106 |
| cycles | (20 mV₀₋ₚ, | (90 mV₀₋ₚ | (80 mV₀₋ₚ, |
| | 479 ms) | 487 ms) | 452 ms) |

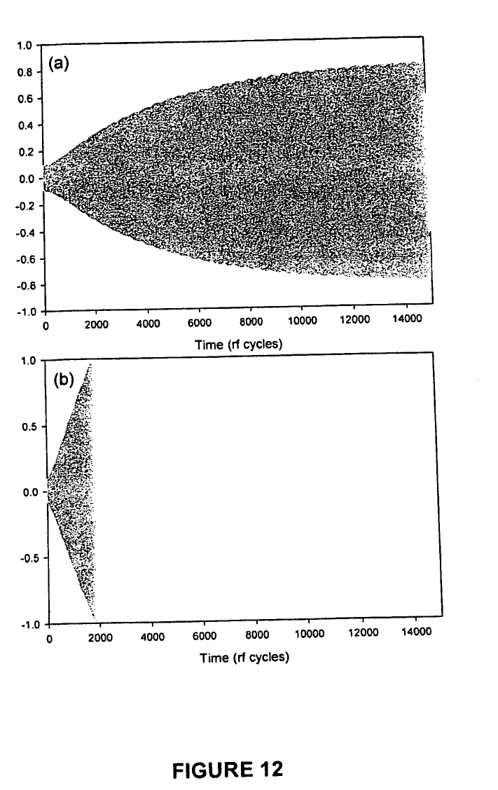

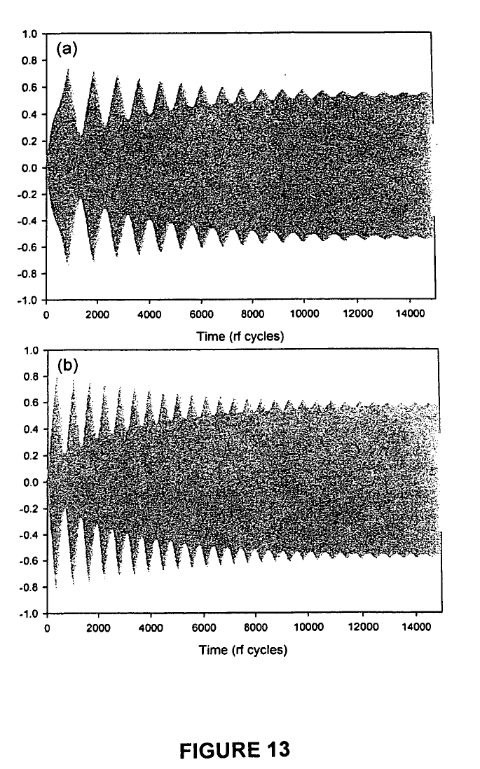

The higher MS/MS efficiency with an added multipole field has been attributed to the frequency shift that occurs as the amplitude of oscillation increases—see references [1a]and [8]. With a pure quadrupole field, the frequency of oscillation is independent of amplitude. If the amplitude of excitation is increased in an attempt to gain a greater degree of fragmentation through more energetic collisions, ions can be ejected. This is illustrated in FIGS. 12a and 12b. FIG. 12a shows the trajectory of an ion of m/z=609, trapped at q=0.20, excited at its resonant frequency of 54.739 kHz, in the presence of 0.14 mTorr of N₂ (trapping frequency 768 kHz). The collision cross section was taken as 280 Å², which gives a damping constant λ=187 s⁻¹. The excitation amplitude is 10 mV₀₋ₚ. These conditions are chosen to match approximately the conditions in FIG. 9a where the precursor starts to show depletion. The amplitude of oscillation increases with time until a steady state is reached where the amplitude is ca. 0.8r₀ or 3.3 mm. FIG. 12b shows the trajectory when the excitation amplitude is increased to 35 mV₀₋ₚ. The amplitude of oscillation increases more rapidly and after about 2000 rf cycles (2.6 ms) the ion strikes a rod and is lost. This is qualitatively similar to the data of FIG. 9a where ions are lost at amplitudes greater than about 30 mV₀₋ₚ. In contrast, when there is an octopole field added, the ion trajectories are quite different. FIG. 13a shows excitation of an ion of m/z=609 in quadrupole field (r₀=4.5 mm) with a +4% octopole component, at a pressure of 0.14 mTorr (q=0.2031, trapping frequency 768 kHz; the conditions of FIG. 9e). The excitation amplitude is 75 mV₀₋ₚ. The ions are excited at 56.954 kHz, which 1.351 kHz above their unperturbed frequency (ω₀/2π=55.602 kHz). The amplitude of ion oscillation increases but a beat-like pattern is formed. Because the frequency of ion oscillation depends on the amplitude of oscillation, the excitation frequency is alternately in and out of phase with the excitation. Damping by collisions leads to a steady state where the amplitude of oscillation is about 0.54r₀ or 2.4 mm. The amplitudes calculated from eq 19 are 1.8 mm 2.2 mm, in reasonable agreement. When the excitation amplitude is doubled to 150 mV₀₋ₚ the trajectory of FIG. 13b is calculated. The amplitude of oscillation is greater which means there are greater frequency shifts. A transient beat-like pattern is formed before a steady state is reached with an oscillation amplitude of about 0.65r₀ (2.9 mm). The beat-like pattern formed when there is an added multipole field was described by Franzen et al.—see reference [1a], but the effects of damping by collisions were not discussed or illustrated. FIG. 13 shows that when there is an added octopole field, ions can be excited with substantially higher amplitudes without striking the rods, as is seen in the experimental data of FIGS. 8, 9, and 10.

Collings et al.—see reference [8]—have described in detail resonant excitation in a low pressure (nominally 3×10⁻⁵ Torr) linear trap constructed with a round rod set that has essentially the same geometry as our conventional rod set. In contrast to our results at a similar pressure, reserpine ions could be efficiently fragmented. The reasons for the different behavior are not clear. The more efficient fragmentation in that experiment may be due to a number of effects, such as a locally higher gas density especially near the trap entrance, higher internal energies of ions entering the trap, or operation of the trap at 816 kHz instead of 768 kHz. The higher frequency and slightly higher trapping q in that experiment (q=0.21 vs. q=0.20) give a somewhat higher effective potential well depth of 8.0 V compared to a well depth of 6.4 V in our experiments. (Our experiments with the 4% octopole rod set had a well depth of 7.6 V.) Based on trajectory calculations, Collings et al.—see reference [7]—attributed the efficient fragmentation of ions at the low pressure to the presence of higher multipoles in the potential, arising from the use of round rods. A beat pattern more complex than that of FIG. 13 was observed in trajectory calculations.

Other variations and modifications of the invention are possible. All such modifications or variations are believed to be in the sphere and scope of the invention as defined by the claims appended hereto.

1. A method of isolating a first group of ions of a first mass-to-charge ratio from a second group of ions of a second mass-to-charge ratio, the first mass-to-charge ratio being greater than the second mass-to-charge ratio, the method comprising:
(a) establishing and maintaining a two-dimensional substantially quadrupole field to trap ions of mass-to-charge ratios within a selected range of mass-to-charge ratios encompassing both the first mass-to-charge ratio and the second mass-to-charge ratio, wherein the field has a quadrupole harmonic with amplitude A₂, and an octopole harmonic with an amplitude A₄, A₄ being greater than 0.1% of A₂;
(b) trapping ions of mass-to-charge ratios within the selected range of mass-to-charge ratios;
(c) adding an excitation field to the two-dimensional substantially quadrupole field to deplete the abundance of the second group of ions of the second mass-to-charge ratio, while retaining the first group of ions of the first mass-to-charge ratio.

2. The method as defined in claim 1 wherein A4 is greater than 1% of A2.

3. The method as defined in claim 1 wherein A₄ is greater than 3% of A₂.

4. The method as defined in claim 1 wherein step (a) comprises
supplying a voltage V1 to a first pair of rods, the voltage V1 being at least partially-AC; and
supplying a voltage V2 to a second pair of rods, the voltage V2 being at least partially-AC;
wherein the first pair of rods and the second pair of rods surround a central axis of the substantially quadrupole field and extend substantially parallel to the central axis.

5. The method as defined in claim 4 wherein the first rod pair is selected to be of greater transverse dimension than the second rod pair such that A₄ is greater than 1% of A₂.

6. The method as defined in claim 5 further comprising
increasing V2 by a voltage misbalance amount,
decreasing V1 by the voltage misbalance amount, the voltage misbalance amount being selected to minimize an axis potential of the field.

7. The method as defined in claim 5 wherein step (c) comprises
providing a dipole excitation voltage between the first pair of rods.

8. The method as defined in claim 7 wherein the first pair of rods and the second pair of rods are substantially cylindrical.

9. The method as defined in claim 1 further comprising, after step c), ejecting the first group of ions to a detector for detection.

10. The method as defined in claim 1 wherein the first group of ions and the second group of ions comprise different isotopes.

11. A method of isolating a first group of ions of a first mass-to-charge ratio from a second group of ions of a second mass-to-charge ratio, the first mass-to-charge ratio being greater than the second mass-to-charge ratio, the method comprising:
(a) establishing and maintaining a two-dimensional substantially quadrupole field to trap ions of mass-to-charge ratios within a selected range of mass-to-charge ratios encompassing both the first mass-to-charge ratio and the second mass-to-charge ratio, wherein the field has a quadrupole harmonic with amplitude A₂, and a higher order harmonic with an amplitude A_{N}, A_{N} being greater than 0.1% of A₂;
(b) trapping ions of mass-to-charge ratios within the selected range of mass-to-charge ratios;
(c) adding an excitation field to the two-dimensional substantially quadrupole field to deplete the abundance of the second group of ions while retaining the first group of ions.

12. The method as defined in claim 11 wherein the higher order harmonic comprises at least one of a hexapole harmonic, an octopole harmonic, and an odd field harmonic of higher order than the hexapole harmonic.

13. The method as defined in claim 11 further comprising, after step c), ejecting the first group of ions to a detector for detection.

14. The method as defined in claim 11 wherein the first group of ions and the second group of ions comprise different isotopes.

15. A method of isolating a selected group of ions from ions of lower mass-to-charge ratio, the method comprising:
(a) establishing and maintaining a two-dimensional substantially quadrupole field to trap the selected group of ions, wherein the field has a quadrupole harmonic with amplitude A₂, and a higher order harmonic with an amplitude A_{N}, A_{N} being greater than 0.1% of A₂;
(b) trapping the selected group of ions in the field;
(c) determining an oscillation frequency at a selected amplitude of excitation for the selected group of ions;
(d) adding an excitation field at the selected amplitude of excitation to the two-dimensional substantially quadrupole field to deplete ions within a depletion peak having a low frequency side slightly above the oscillation frequency at the selected amplitude of excitation for the selected group of ions.

16. The method as defined in claim 15 wherein the higher order harmonic comprises at least one of a hexapole harmonic, an octopole harmonic, and an odd field harmonic of higher order than the hexapole harmonic.

17. The method as defined in claim 15 wherein the higher order harmonic comprises an octopole harmonic.

18. The method as defined in claim 15 wherein
the method further comprises determining a second group of ions to be depleted, the selected group of ions having a greater mass-to-charge ratio than the second group of ions
step c) further comprises determining a second oscillation frequency at the selected amplitude of excitation for the second group of ions; and,
step d) further comprises determining the excitation field such that the second oscillation frequency falls within the depletion peak.
